(19) United States
(12) Patent Application Publication
(10) Pub. No.: US 2021/0389686 A1
(43) Pub. Date: Dec. 16, 2021

(54) TONER, TONER ACCOMMODATING UNIT, IMAGE FORMING APPARATUS, AND IMAGE FORMING METHOD

(71) Applicant: RICOH COMPANY, LTD., Tokyo (JP)

(72) Inventors: Hidekazu KAKINUMA, Shizuoka (JP); Ryohei YAMAGUCHI, Shizuoka (JP); Hiroshi YAMADA, Shizuoka (JP)

(21) Appl. No.: 17/325,377

(22) Filed: May 20, 2021

(30) Foreign Application Priority Data
Jun. 10, 2020 (JP) 2020-100739

(51) Int. Cl. G03G 9/087; G03G 15/08; G03G 9/08; G03G 9/09

(52) U.S. Cl. CPC G03G 9/08755; G03G 15/0822; G03G 9/0906; G03G 9/08782; G03G 9/0904; G03G 9/0804

(57) ABSTRACT

A toner is provided comprising toner particles each comprising: a toner base particle containing an inorganic filler; and an external additive. A relation 0.30≤S2/S1≤0.70 is satisfied, where S1 and S2 respectively represent an area of the toner base particle and a total area of the inorganic filler exposed at a surface of the toner base particle. A standard deviation SD of an area distribution of S2 is less than 0.040 μm². A volume average particle diameter of the toner is 4.0 μm or more and less than 6.0 μm. A relation B/A≥0.7 is satisfied, where A and B are respectively average values of Q1/D1 and Q2/D2, where Q1 and D1 are respectively a charge amount and a particle diameter of the toner particle having a size of 4.0 μm or more and less than 6.0 μm, and Q2 and D2 are those of the toner particle having a size of 6.0 μm or more and less than 8.0 μm.

### CROSS-REFERENCE TO RELATED APPLICATIONS

This patent application is based on and claims priority pursuant to 35 U.S.C. § 119(a) to Japanese Patent Application No. 2020-100739, filed on Jun. 10, 2020, in the Japan Patent Office, the entire disclosure of which is hereby incorporated by reference herein.

### BACKGROUND

### Technical Field

The present disclosure relates to a toner, a toner accommodating unit, an image forming apparatus, and an image forming method.

### Description of the Related Art

In image forming processes such as electrophotography, a latent image (e.g., an electrostatic latent image) is formed on an image bearer (e.g., photoconductive substance), and a charged toner is attached to the electrostatic latent image to form a visible image. The visible image formed of the toner is transferred onto a transfer medium (e.g., paper), and finally fixed thereon by heat, pressure, solvent vapor, etc., thus outputting an image.

Such image forming processes can be roughly classified into two-component development methods and one-component development methods. In the two-component development methods, toner and carrier are stir-mixed and triboelectrically charged, and the charged toner is used to form a visible image. In the one-component development methods, toner particles are charged without using carrier. Two-component development methods have been widely used for printers, copiers, and multifunction peripherals, which require high speed and image reproducibility, for their stability in charging toner particles, charge rising performance, and stability in image quality for an extended period of time, etc.

In recent years, in the field of electrostatic charge image development technique, how to improve image quality has been studied from various viewpoints. In particular, it has been recognized that making the toner size small and making the toner shape spherical are extremely effective for improving image quality. Therefore, development of toner particles with uniform particle diameter is being actively carried out. However, physical properties of toner, as a powder, are not uniform, and there are some toners which do not have sufficient charging ability. In particular, a toner having a large particle diameter has a small specific surface area, so that triboelectric charging of the toner with carrier will be insufficient and the charge level of the toner will be insufficient. Further, charging ability of a carrier contained in a developer in a developing device deteriorates with long-term use, and it becomes more difficult to charge toner in a short time period. Such toner with an insufficient charge level is less likely to be constrained by an electric force with the carrier, and scatters on the air flow generated in the device and contaminates the inside of the device.

In attempting to improve charging ability of toner, a method of adding a charge controlling agent has been proposed.

On the other hand, in recent years, how to reduce energy used to fix toner to form an image has been studied, for saving energy and increasing image forming speed. As a result, a low-temperature fixing toner that is fixable at low temperatures is demanded.

The charge controlling agent effectively improves charging ability of toner but inhibits fixing of toner at low temperatures (“low-temperature fixing”). To achieve both charging ability and low-temperature fixing, there is a demand for a technique for improving charging ability of a toner having a large particle diameter that causes toner scattering, without using any charge controlling agent.

### SUMMARY

In accordance with some embodiments of the present invention, a toner is provided. The toner comprises toner particles each comprising: a toner base particle comprising a binder resin, a colorant, and an inorganic filler; and an external additive. In a backscattered electron image of the toner from which the external additive has been removed, obtained using a scanning electron microscope, the following relation is satisfied:

0.30S2/S1≤0.70

where S1 represents an area of the toner base particle and S2 represents a total area of the inorganic filler exposed at a surface of the toner base particle. A standard deviation SD of an area distribution of the total area S2 of the inorganic filler exposed at the surface of the toner base particle is less than 0.040 μm². A volume average particle diameter of the toner, measured using a charge distribution analyzer, is 4.0 μm or more and less than 6.0 μm. The following relation is satisfied:

B/A≥0.7

where A is an average value of Q1/D1 where Q1 and D1 respectively represent a charge amount and a particle diameter of one of the toner particles having a particle diameter of 4.0 m or more and less than 6.0 μm, and B is an average value of Q2/D2 where Q2 and D2 respectively represent a charge amount and a particle diameter of one of the toner particles having a particle diameter of 6.0 μm or more and less than 8.0 m, where the particle diameter is measured using the charge distribution analyzer.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an image forming apparatus according to an embodiment of the present invention;

FIG. 2 is a schematic diagram illustrating an image forming apparatus according to an embodiment of the present invention;

FIG. 3 is a schematic diagram illustrating an image forming apparatus according to an embodiment of the present invention; and

FIG. 4 is a schematic diagram illustrating an image forming apparatus according to an embodiment of the present invention.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant

In accordance with some embodiments of the present invention, a toner is provided that has stable charging ability for not causing background stains and in-machine contamination by toner scattering, and excellent low-temperature fixability.

Hereinafter, a toner, a toner accommodating unit, an image forming apparatus, and an image forming method according to some embodiments of the present invention are described with reference to the drawings. Incidentally, it is to be noted that the following embodiments are not limiting the present invention and any deletion, addition, modification, change, etc. can be made within a scope in which person skilled in the art can conceive including other embodiments, and any of which is included within the scope of the present invention as long as the effect and feature of the present invention are demonstrated.

### Toner

The toner according to an embodiment of the present invention comprises toner particles each comprising: a toner base particle comprising a binder resin, a colorant, and an inorganic filler; and an external additive.

In a backscattered electron image of the toner from which the external additive has been removed, obtained using a scanning electron microscope, the following relation is satisfied: 0.30≤S2/S1≤0.70, where S1 represents an area of the toner base particle and S2 represents a total area of the inorganic filler exposed at a surface of the toner base particle. A standard deviation SD of an area distribution of the total area S2 of the inorganic filler exposed at the surface of the toner base particle is less than 0.040 μm².

A volume average particle diameter of the toner, measured using a charge distribution analyzer, is 4.0 μm or more and less than 6.0 μm.

The following relation is satisfied: B/A≥0.7, where A is an average value of Q1/D1 where Q1 and D1 respectively represent a charge amount and a particle diameter of one of the toner particles having a particle diameter of 4.0 μm or more and less than 6.0 m, and B is an average value of Q2/D2 where Q2 and D2 respectively represent a charge amount and a particle diameter of one of the toner particles having a particle diameter of 6.0 μm or more and less than 8.0 μm, where the particle diameter is measured using the charge distribution analyzer.

### S2/S1, Standard Deviation SD, Particle Diameter, and Q/D

In the present disclosure, the inorganic filler is exposed at the surface of the toner base particle. As the inorganic filler is exposed at the surface, the toner base particle exerts an improved charging ability and maintains a high charging ability even it is coated with the external additive.

The state (may be referred to as “dispersion state”) of the inorganic filler exposed at the surface of the toner base particle can be observed in a backscattered electron image obtained using a scanning electron microscope. In the present disclosure, a ratio of an area where the inorganic filler is exposed is determined based on an area of the toner base particle and an area of the inorganic filler. The area of the toner base particle and the area of the inorganic filler can be determined by, for example, binarizing the backscattered electron image.

In the present disclosure, in a backscattered electron image of the toner from which the external additive has been removed, obtained using a scanning electron microscope, the following relation is satisfied: 0.30≤S2/S1≤0.70, where S1 represents an area of the toner base particle and S2 represents a total area of the inorganic filler exposed at a surface of the toner base particle. S2/S1 indicates the degree of exposure of the inorganic filler. When S2/S1 is less than 0.30, the area where the inorganic filler is exposed is small, so that the charging ability of the toner base particle is insufficient, causing undesirable phenomena such as toner scattering. When S2/S1 is larger than 0.70, the area where the inorganic filler is exposed is large, so that it becomes difficult to make the external additive sufficiently adhere to the toner base particle.

A method for adjusting S2/S1 to be in the above-described range can be appropriately selected. One example method involves controlling the content of the inorganic filler. Other examples include a method of controlling the particle diameter of the inorganic filler, and a method of modifying the inorganic filler with a surface treatment agent or organic substance to control the dispersion state thereof in the toner base particle.

In the present embodiment, the inorganic filler exposed at the surface of the toner base particle is in the form of fine grain. As the inorganic filler is in the form of fine grain, the specific surface area of the inorganic filler is increased, and the charging ability of the toner base particles is improved. Whether or not the inorganic filler exposed at the surface of the toner base particle is in the form of fine grain can be determined by a standard deviation SD of an area distribution of the total area S2 of the inorganic filler. For example, in an area distribution chart having the vertical axis showing the number and the horizontal axis showing S2, as the inorganic filler becomes finer, the average value of S2 shifts to a side where S2 is smaller. In this case, the standard deviation SD becomes smaller. When the standard deviation SD is small, the variation of S2 of the inorganic filler is small and many of the inorganic filler grains are fine. Therefore, the charging ability is further improved.

In the present embodiment, in a backscattered electron image obtained using a scanning electron microscope, the standard deviation SD of the area distribution of the total area S2 of the inorganic filler exposed at the surface of the toner base particle is less than 0.040 μm². When the standard deviation SD is 0.040 μm² or more, the inorganic filler grains are not sufficiently fine and the effect of improving the charging ability is insufficient, resulting in deterioration of low-temperature fixability.

Preferably, the standard deviation SD is less than 0.020 μm². In this case, the charging ability is further improved.

A method for adjusting the standard deviation SD of the area distribution of the total area S2 of the inorganic filler exposed at the surface of the toner base particle to be less than 0.040 μm² can be appropriately selected. One example method involves controlling the type of the inorganic filler.

Preferably, the inorganic filler contained in the toner base particle contains aluminum. In particular, the inorganic filler containing aluminum is capable of greatly improving the charging ability of the toner base particle. More preferably, the inorganic filler contains a layered inorganic mineral in which at least part of interlayer ions is modified with an organic ion. The inorganic filler which is modified with an organic ion can be unevenly distributed in the toner base particle. Further, the inorganic filler containing the layered inorganic mineral can be uniformly dispersed over the entire of the toner base particle.

In addition to the above, the method for adjusting the standard deviation SD to be less than 0.040 μm² may be a method of controlling the dispersing time and dispersing strength in the process of dispersing the inorganic filler in the toner base particle.

A method of obtaining a backscattered electron image of the toner from which the external additive has been removed, using a scanning electron microscope, is described below. Further, a method of determining the area S1 of the toner base particle, the total area S2 of the inorganic filler exposed at the surface of the toner base particle, and the standard deviation SD of the area distribution of the total area S2 of the inorganic filler are described below.

First, to observe the inorganic filler at the surface of the toner base particle, the external additive adhering to the toner base particle is removed by the following method to isolate the toner base particle. The method involves adding a toner to a DRIWEL aqueous solution and leaving it to stand, then applying ultrasonic energy thereto using an ultrasonic homogenizer, followed by filtration, washing, and drying. The method is more specifically described below.

(1) In a 200-mL ointment bottle, 100 mL of ion-exchange water and 4.4 mL of a 33% by mass aqueous solution of DRIWEL (product of FUJIFILM Corporation) containing a surfactant are put; then 5 g of toner are added to the resulted mixed solution, mixed well by shaking the bottle 30 times, and left to stand for 1 hour or more.

(2) Next, after shaking the bottle 20 times to stir the toner, ultrasonic waves are applied for 2 minutes using an ultrasonic homogenizer (HOMOGENIZER, model VCX750, CV33, product of Sonics & Materials, Inc.) setting an output dial to 50% under the following conditions to disperse the toner.

Ultrasonic Conditions
Vibration time: continuous 60 seconds
Amplitude: 20 W (30%)
Vibration start temperature: 23° C.±1.5° C.

(3) The resulted dispersion liquid is suction filtered with a filter paper (trade name: qualitative filter paper (No. 2, 110 mm), product of Advantec Toyo Kaisha, Ltd.), washed again with ion-exchange water twice, and filtered. After removing the liberated external additive, the toner is dried. The toner base particle from which the external additive has been removed is thus obtained.

In the present embodiment, the dispersion state of the inorganic filler at the surface of the toner base particle is observed using a scanning electron microscope (SU8230, product of Hitachi High-Technologies Corporation). The observation conditions involve a backscattered electron image mode and an acceleration voltage of 0.8 kV In the backscattered electron image, the inorganic filler is observed as a high-intensity contrast portion.

Next, the captured backscattered electron image is binarized using image processing software to determine the area S1 [μm²] of the entire toner base particle. The high-intensity contrast portion of the inorganic filler is binarized in the same manner. The total area S2 [μm²] of the inorganic filler exposed at the surface of the toner base particle is determined from the area distribution of the high-intensity contrast portion. The area distribution of the total area S2 of the inorganic filler is determined from the above-determined S2, then the standard deviation SD [m²] is determined.

In the present embodiment, a volume average particle diameter of the toner, measured using a charge distribution analyzer, is 4.0 μm or more and less than 6.0 m, and preferably 4.0 μm or more and 5.0 μm or less. A reason for selecting the volume average particle diameter of 4.0 μm or more and less than 6.0 μm in the present embodiment is as follows. When it is less than 4.0 m, the toner may fuse to the surface of a carrier during a long-term stirring in a developing device to lower the charging ability of the carrier. When it is 6.0 μm or more, minute dot reproducibility is insufficient, so that it is difficult to form a high-resolution and high-quality image.

The toner of the present embodiment has a charge amount Q and a particle diameter D having the following relation. That is, B/A≥0.7, where A is an average value of Q1/D1 where Q1 and D1 respectively represent a charge amount and a particle diameter of one of the toner particles having a particle diameter of 4.0 μm or more and less than 6.0 m, and B is an average value of Q2/D2 where Q2 and D2 respectively represent a charge amount and a particle diameter of one of the toner particles having a particle diameter of 6.0 μm or more and less than 8.0 μm, where the particle diameter is measured using the charge distribution analyzer.

Here, “toner particle” refers to one of the toner particles contained in the toner. Toner is generally composed of a plurality of toner particles, but the terms “toner” and “toner particle” may be used without strictly distinguishing them.

The charge amount of a toner particle depends on the particle diameter. A toner particle having a large particle diameter has a small specific surface area, so that such a toner particle is less likely to be triboelectrically charged through stirring with carrier and cannot charged in a short time. Therefore, such a toner particle cannot be sufficiently charged and bound by the carrier, when supplied into a developing device, and tends to scatter.

On the other hand, since the toner of the present embodiment has an improved charging ability by containing fine grains of the inorganic filler, the particle diameter dependence of the charge amount is small, and even a toner particle having a large particle diameter exerts high charging ability. Therefore, the toner of the present embodiment can be uniformly charged immediately after the toner has been supplied into the developing device, suppressing generation of scattered toner particles.

In the present embodiment, in determining B/A, toner particles having a particle diameter of 6.0 μm or more and less than 8.0 m are taken into consideration. The charge amount and particle diameter of the toner particle having a particle diameter in this range are respectively denoted as Q2 and D2. A reason why the particle diameter of 6.0 μm or more and less than 8.0 μm is taken into consideration is as follows. Toner particles having a particle diameter of 6.0 μm or more are remarkable in a decrease in the charge amount caused due to a decrease in the specific surface area. This is why the particle diameter of 6.0 μm or more is considered. Toner particles having a particle diameter of 8.0 μm or more often remain in the developing device because of their large particle diameter, and it is difficult to use them for image development. This is why the toner particles having a particle diameter of less than 8.0 μm are considered.

Q/D [fC/μm], which is the ratio of the charge amount Q to the particle diameter D, means the charge amount per unit diameter. The inventors of the present invention have compared the charge amount of each one of the toner particles, and have come to pay attention to the uniformity in charge amount of all the toner particles. Specifically, the inventors focus on B/A, that is, (average value of Q2/D2)/(average value of Q1/D1). When B/A≥0.7 is satisfied, it means that the uniformity in charge amount of all the toner particles is high. In this case, the charging ability of the toner is good, and the toner is suppressed from scattering.

B/A≥0.7 is satisfied when, for example, the type of the inorganic filler is suitably selected. Similar to the above, preferred examples of the inorganic filler include an inorganic filler containing aluminum, and a layered inorganic mineral in which at least part of interlayer ions is modified with an organic ion. Such an inorganic filler can be uniformly dispersed over the entire toner particles, thereby improving the charging ability of the toner particles.

Preferably, B/A≥0.9 is satisfied. In this case, the toner can be more suppressed from scattering. More preferably, the standard deviation SD of the area distribution of the total area S2 of the inorganic filler is less than 0.020 μm² and, at the same time, B/A≥0.9 is satisfied. In this case, the toner can be more suppressed from scattering.

The volume average particle diameter [μm] of the toner and the charge amount Q [fC] and particle diameter D [μm] of each toner particle are determined by a measurement using a charge distribution analyzer. As the charge distribution analyzer, E-SPART ANALYZER (product of Hosokawa Micron Corporation) is used. One example measurement method is as follows.

A developer, in which a toner and a carrier are mixed to have a toner concentration of 7% by mass, is placed in a cylindrical container (having a diameter of 25 mm and a length of 30 mm) and stirred for 1 minute at a rotation speed of 280 rpm. Next, the developer is magnetically adhered to the disk of the E-SPART ANALYZER, air is blown to the developer to separate the toner from the carrier, and the charge amount and particle diameter of the toner are measured.

The measurement conditions for the E-SPART ANALYZER involve a nitrogen gas flow rate of 0.3 NL/min and a gas pressure of 0.3 atm. The total number of particles to be measured is, for example, 3,000. The true specific gravity of the particles is 1.2 g/cm³.

### Toner Production Method and Toner Materials

Next, production methods and materials of the toner are described.

The toner of the present embodiment comprises toner particles each comprising: a toner base particle comprising a binder resin, a colorant, and an inorganic filler; and an external additive. The external additive is mixed with the toner base particles using, for example, a HENSCHEL MIXER, to be adhered to the toner base particles. The toner base particles may further contain other components (e.g., a release agent, a surfactant, a fluidity improving agent, a cleanability improving agent, a magnetic material, a lubricant, an abrasive), as needed.

### Inorganic Filler

Examples of the inorganic filler include, but are not particularly limited, calcium carbonate, kaolin clay, talc, and barium sulfate. Each of these may be used alone or in combination with others. The inorganic filler may be surface-treated with a silane coupling agent, a surfactant, or a metal soap. The inorganic filler may be adjusted to have a desired particle diameter distribution by means of classification.

Preferably, the inorganic filler contained in the toner base particle contains aluminum. In particular, the inorganic filler containing aluminum is capable of greatly improving the charging ability of the toner base particle. More preferably, the inorganic filler contains a layered inorganic mineral in which at least part of interlayer ions is modified with an organic ion. The inorganic filler which is modified with an organic ion can be unevenly distributed in the toner base particle. Further, the inorganic filler containing the layered inorganic mineral can be uniformly dispersed over the entire of the toner base particle.

In the present embodiment, the layered inorganic mineral refers to an inorganic mineral formed of laminated layers each having a thickness of several nanometers. The modification with an organic ion refers to introduction of the organic ion into the ions present between the layers. Specifically, it is described in Japanese Translation of PCT International Application Publication Nos. 2003-515795, 2006-500605, and 2006-503313. It is also referred to as “intercalation” in the broad sense.

Examples of layered inorganic minerals include smectite families (e.g., montmorillonite, saponite), kaolin families (e.g., kaolinite), magadiite, and kanemite. Modified layered inorganic minerals have high hydrophilicity due to their modified layered structure.

When a layered inorganic mineral without any modification is used for a toner which is produced through the processes of dispersion and granulation in an aqueous medium, the layered inorganic mineral migrates to the aqueous medium without making the toner shape irregular. On the other hand, a modified layered inorganic mineral has a high degree of hydrophilicity and easily makes the toner shape irregular. The modified layered inorganic mineral makes the toner shape irregular in the process of producing fine particles of the toner. The modified layered inorganic mineral is made to present near the surface of the toner particles in large amounts and can be uniformly dispersed over the entire of the toner base particles. In addition, the modified layered inorganic mineral has functions of well adjusting the charge and improving low-temperature fixability.

In the present disclosure, preferably, a modified layered inorganic mineral having a smectite-based crystalline structure modified with an organic cation is used. A metallic anion can be introduced by substituting part of divalent metals in the layered inorganic mineral with trivalent metals. Since the metallic anion has high hydrophilicity, it is preferable that at least part of the metallic anion be modified with an organic anion.

Examples of organic ion modifying agents for modifying at least part of ions in the layered inorganic mineral with an organic ion include, but are not limited to, quaternary alkylammonium salts, phosphonium salts, and imidazolium salts. Among these, quaternary alkylammonium salts are preferred.

Specific examples of the quaternary alkylammonium include, but are not limited to, trimethylstearylammonium, dimethylstearylbenzylammonium, dimethyloctadecylammonium, and oleylbis(2-hydroxyethyl)methylammonium.

Examples of the organic ion modifying agents further include sulfates, sulfonates, carboxylates, and phosphates each having a branched, non-branched, or cyclic alkyl (C1-C44), alkenyl (C1-C22), alkoxy (C8-C32), hydroxyalkyl (C2-C22), ethylene oxide, or propylene oxide. In particular, carboxylates having an ethylene oxide backbone are preferred.

By modifying at least part of the layered inorganic mineral with an organic ion, the modified layered inorganic mineral is given a proper degree of hydrophobicity. Therefore, an oil phase containing toner components and/or toner component precursors exhibits a non-Newtonian viscosity, which makes the toner shape irregular.

Specific examples of the layered inorganic mineral at least part of which is modified with an organic ion include, but are not limited to, montmorillonite, bentonite, hectorite, attapulgite, sepiolite, and mixtures thereof. Of these, montmorillonite or bentonite containing aluminum is preferred because aluminum is effective in improving the charging ability.

Examples of commercially-available products of the layered inorganic mineral at least part of which is modified with an organic cation include, but are not limited to: quaternium-18 bentonite such as BENTONE 3, BENTONE 38, and BENTONE 38V (products of Rheox, Inc.), TIXOGEL VP (product of United Catalyst Corporation), and CLAYTONE 34, CLAYTONE 40, and CLAYTONE XL (products of Southern Clay Products, Inc.); stearalkonium bentonite such as BENTONE 27 (product of Rheox, Inc.), TIXOGEL LG (product of United Catalyst Corporation), and CLAYTONE AF and CLAYTONE APA (products of Southern Clay Products, Inc.); and quaternium-18/benzalkonium bentonite such as CLAYTONE HT and CLAYTONE PS (products of Southern Clay Products, Inc.). Among these, CLAYTONE AF and CLAYTONE APA are particularly preferred.

Further, as the layered inorganic mineral at least part of which is modified with an organic anion, a DHT-4A (product of Kyowa Chemical Industry Co., Ltd.) modified with an organic anion represented by the following general formula (1) is particularly preferred. Specific examples of the compound represented by the general formula (1) include HITENOL 330T (product of DKS Co., Ltd.).

R₁(OR₂)ₙOSO₃M General Formula (1)

In the general formula (1), R₁ represents an alkyl group having 13 carbon atoms, R₂ represents an alkylene group having 2 to 6 carbon atoms, n represents an integer of from 2 to 10, and M represents a monovalent metal element.

The content of the inorganic filler is not particularly limited and can be suitably varied. Preferably, the proportion thereof in the toner base particles is from 0.05% to 5% by mass, and more preferably from 0.1% to 2% by mass. In this range, the charging ability of the toner is further improved.

### Binder Resin

The binder resin contained in the toner base particles of the toner of the present disclosure is not particularly limited and can be suitably selected to suit to a particular application. Examples thereof include, but are not limited to, polyester resin, silicone resin, styrene-acrylic resin, styrene resin, acrylic resin, epoxy resin, diene resin, phenol resin, terpene resin, coumarin resin, amide-imide resin, butyral resin, urethane resin, and ethylene-vinyl acetate resin. Each of these can be used alone or in combination with others.

Among these, polyester resin that has sufficient flexibility even if the molecular weight is low is preferred as a resin component (resin matrix) of the toner, which sharply melts at the time the toner is fixed and smoothens the surface of the resulted image. Such polyester may be used in combination with another resin.

Preferred examples of the polyester include, but are not limited to, urea-modified polyester, a combination of urea-modified polyester and unmodified polyester, and a combination of urea-modified polyester, unmodified polyester, and crystalline polyester.

### Unmodified Polyester

The binder resin may include an unmodified polyester that is free of a bonding unit other than ester bond. The unmodified polyester may be used in combination with any of a binder resin precursor having ester bond, a modified polyester having ester bond and a bonding unit other than the ester bond, a resin precursor capable of producing the modified polyester, and a crystalline polyester.

Preferred examples of the polyester include a polyester obtained by reacting one or more polyols represented by the following general formula (2) with one or more polycarboxylic acids represented by the following general formula (3).

A-(OH)ₘ General Formula (2)

In the general formula (2), A represents an alkyl group having 1 to 20 carbon atoms, an alkylene group, or an aromatic group or heterocyclic aromatic group that may have a substituent; and m represents an integer of from 2 to 4.

B—(COOH)ₙ General Formula (3)

In the general formula (3), B represents an alkyl group having 1 to 20 carbon atoms, an alkylene group, or an aromatic group or heterocyclic aromatic group that may have a substituent; and m represents an integer of from 2 to 4.

Specific examples of the polyols represented by the general formula (2) include, but are not limited to, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, bisphenol A, bisphenol A ethylene oxide adduct, bisphenol A propylene oxide adduct, hydrogenated bisphenol A, hydrogenated bisphenol A ethylene oxide adduct, and hydrogenated bisphenol A propylene oxide adduct.

Specific examples of the polycarboxylic acids represented by the general formula (3) include, but are not limited to, maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenyl succinic acid, isooctyl succinic acid, isododecenyl succinic acid, n-dodecyl succinic acid, isododecyl succinic acid, n-octenyl succinic acid, n-octyl succinic acid, isooctenyl succinic acid, isooctyl succinic acid, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, empol trimer acid, cyclohexanedicarboxylic acid, cyclohexenedicarboxylic acid, butanetetracarboxylic acid, diphenylsulfonetetracarboxylic acid, and ethylene glycol bis(trimellitic acid).

### Non-Crystalline Polyester

In the present disclosure, a non-crystalline unmodified polyester is preferably used as a binder resin component. It is preferable that an unmodified polyester and a modified polyester which is obtained by a cross-linking and/or elongation reaction of a binder resin precursor comprising a modified-polyester-based resin are at least partially compatibilized with each other. In this case, low-temperature fixability and hot offset resistance are improved. Therefore, it is preferable that the polyol components and the polycarboxylic acid components of the modified polyester and the unmodified polyester have similar compositions. Further, a non-crystalline polyester used for a crystalline polyester dispersion liquid can also be used as the unmodified polyester as long as it is unmodified.

Preferably, the unmodified polyester has an acid value of from 1 to 50 KOHmg/g, more preferably from 5 to 30 KOHmg/g. When the acid value is 1 KOHmg/g or higher, the toner becomes more negatively-chargeable and more compatible with paper when being fixed thereon, improving low-temperature fixability. When the acid value is higher than 50 KOHmg/g, charge stability, particularly charge stability against environmental fluctuation, may be poor.

Preferably, the unmodified polyester has a hydroxyl value of 5 KOHmg/g or more. The hydroxyl value is measured based on a method according to JIS (Japanese Industrial Standards) K0070-1966.

Specifically, first, 0.5 g of a sample is precisely weighed in a 100-ml volumetric flask, and 5 ml of an acetylating agent is further put in the flask. After being heated in a hot bath at 100±5° C. for 1 to 2 hours, the flask is taken out from the hot bath and let stand to cool. Water is further poured in the flask, and the flask is shaken to decompose acetic anhydride. To completely decompose acetic anhydride, the flask is reheated in the hot bath for 10 minutes or more and thereafter let stand to cool. The wall of the flask is sufficiently washed with an organic solvent.

The hydroxyl value is measured at 23° C. using an automatic potentiometric titrator DL-53 TITRATOR (product of Mettler-Toledo International Inc.) and electrodes DG113-SC (products of Mettler-Toledo International Inc.), and an analysis is performed using an analysis software program LabX Light Version 1.00.000. The calibration of the instrument is performed using a mixed solvent of 120 ml of toluene and 30 ml of ethanol.

Measurement conditions are as follows.
Stir
peed [%] 25
Time [s] 15
EQP titration
Titrant/Sensor
Titrant CH3ONa
Concentration [mol/L] 0.1
Sensor DG115
Unit of measurement mV
Predispensing to volume
Volume [mL] 1.0
Wait time [s] 0
Titrant addition Dynamic
dE (set) [mV] 8.0
dV (min) [mL] 0.03
dV (max) [mL] 0.5
Measure mode Equilibrium controlled
dE [mV] 0.5
dt[s] 1.0
t (min) [s] 2.0
t (max) [s] 20.0
Recognition
Threshold 100.0
Steepestjump only No
Range No
Tendency None
Termination
at maximum volume [mL] 10.0
at potential No
at slope No
after number EQPs Yes
n=1
comb. termination conditions No
Evaluation
Procedure Standard
Potential1 No
Potential2 No
Stop for reevaluation No

### Unmodified Polyester

The modified polyester contains, in its molecular structure, at least an ester bond and a bonding unit other than the ester bond. Such a modified polyester can be obtained by a reaction between a compound having an active hydrogen group (“active-hydrogen-group-containing compound”) and a resin precursor capable of producing a modified polyester that includes a polymer (e.g., polyester) having a functional group reactive with the active hydrogen group of the compound.

Polymer Reactive with Active-Hydrogen-Group-Containing Compound

The polymer (hereinafter “prepolymer”) reactive with the active-hydrogen-group-containing compound is not particularly limited and can be suitably selected from known resins as long as it is a polymer having at least a site reactive with the active-hydrogen-group-containing compound. Specific examples thereof include, but are not limited to, polyol resins, polyacrylic resins, polyester resins, epoxy resins, and derivatives thereof. Among these, polyester resins are particularly preferred for their high flowability and transparency at the time of melting. Each of these can be used alone or in combination with others.

The site reactive with the active-hydrogen-group-containing compound in the prepolymer is not particularly limited and can be suitably selected from known substituents. Specific examples thereof include, but are not limited to, isocyanate group, epoxy group, carboxyl group, and acid chloride group. Each of these groups may be included alone or in combinations with others. Among these, isocyanate group is particularly preferred.

In particular, a urea-bond-forming-group-containing polyester (“RMPE”) is preferred as the prepolymer because the molecular weight of high-molecular-weight components thereof is easily adjustable and such a polyester is capable of securing oilless low-temperature fixing property of dry toner, particularly excellent releasability and fixability in a fixing system free of a mechanism of applying a releasing oil to a heat-fixing member.

Specific examples of the urea-bond-forming group include, but are not limited to, isocyanate group. When the urea-bond-forming group in the urea-bond-forming-group-containing polyester (RMPE) is isocyanate group, an isocyanate-group-containing polyester prepolymer (A) is particularly preferred as the urea-bond-forming-group-containing polyester (RMPE).

The isocyanate-group-containing polyester prepolymer (A) is not particularly limited and can be suitably selected to suit to a particular application. Examples thereof include, but are not limited to, a polycondensation product of a polyol (PO) with a polycarboxylic acid (PC), which is obtained by reacting an active-hydrogen-group-containing polyester with a polyisocyanate (PIC).

The polyol (PO) is not particularly limited and can be suitably selected to suit to a particular application. Examples thereof include, but are not limited to, a diol (DIG), a trivalent or higher polyol (TO), and a mixture of a diol (DIO) with a trivalent or higher polyol (TO). Each of these can be used alone or in combination with others. Among these, a diol (DIO) alone and a mixture of a diol (DIO) with a small amount of a trivalent or higher polyol (TO) are preferred.

Specific examples of the diol (DIO) include, but are not limited to, alkylene glycols, alkylene ether glycols, alicyclic diols, alkylene oxide adducts of alicyclic diols, bisphenols, and alkylene oxide adducts of bisphenols.

Preferred examples of the alkylene glycols include those having 2 to 12 carbon atoms, such as ethylene glycol, 1,2-propylene glycol, 1,3-propylene glycol, 1,4-butanediol and 1,6-hexanediol.

Specific examples of the alkylene ether glycols include, but are not limited to, diethylene glycol, triethylene glycol, dipropylene glycol, polyethylene glycol, polypropylene glycol, and polytetramethylene ether glycol.

Specific examples of the alicyclic diols include, but are not limited to, 1,4-cyclohexanedimethanol and hydrogenated bisphenol A. Specific examples of the alkylene oxide adducts of alicyclic diols include, but are not limited to, those obtained by adding alkylene oxides (e.g., ethylene oxide, propylene oxide, butylene oxide) to alicyclic dialcohols. Specific examples of the bisphenols include, but are not limited to, bisphenol A, bisphenol F, and bisphenol S. Specific examples of the alkylene oxide adducts of bisphenols include, but are not limited to, those obtained by adding alkylene oxides (e.g., ethylene oxide, propylene oxide, butylene oxide) to bisphenols. Among these, alkylene glycols having 2 to 12 carbon atoms, and alkylene oxide adducts of bisphenols are preferred; and alkylene oxide adducts of bisphenols, and mixtures of alkylene oxide adducts of bisphenols with alkylene glycols having 2 to 12 carbon atoms are more preferred.

Preferred examples of the trivalent or higher polyol (TO) include those having 3 to 8 valences or more, such as trivalent or higher polyvalent aliphatic alcohols, trivalent or higher polyphenols, and alkylene oxide adducts of trivalent or higher polyphenols.

Specific examples of the trivalent or higher polyvalent aliphatic alcohols include, but are not limited to, glycerin, trimethylolethane, trimethylolpropane, pentaerythritol, and sorbitol. Specific examples of the trivalent or higher polyphenols include, but are not limited to, trisphenols (e.g., Trisphenol PA, product of Honshu Chemical Industry Co., Ltd.), phenol novolac, and cresol novolac. Specific examples of the alkylene oxide adducts of trivalent or higher polyphenols include, but are not limited to, those obtained by adding alkylene oxides (e.g., ethylene oxide, propylene oxide, butylene oxide) to trivalent or higher polyphenols.

The mass ratio (DIO:TO) between the diol (DIO) and the trivalent or higher polyol (TO) in the mixture of the diol (DIO) and the trivalent or higher polyol (TO) is preferably 100:(0.01 to 10), and more preferably 100:(0.01 to 1).

The polycarboxylic acid (PC) is not particularly limited and can be suitably selected to suit to a particular application. Examples thereof include, but are not limited to, a dicarboxylic acid (DIC), a trivalent or higher polycarboxylic acid (TC), and a mixture of a dicarboxylic acid (DIC) with a trivalent or higher polycarboxylic acid (TC). Each of these can be used alone or in combination with others. Among these, a dicarboxylic acid (DIC) alone and a mixture of a dicarboxylic acid (DIC) with a small amount of a trivalent or higher polycarboxylic acid (TC) are preferred.

Specific examples of the dicarboxylic acid (DIC) include, but are not limited to, alkylene dicarboxylic acids, alkenylene dicarboxylic acids, and aromatic dicarboxylic acids. Specific examples of the alkylene dicarboxylic acids include, but are not limited to, succinic acid, adipic acid, and sebacic acid. Preferred examples of the alkenylene dicarboxylic acids include those having 4 to 20 carbon atoms, such as maleic acid and fumaric acid. Preferred examples of the aromatic dicarboxylic acids include those having 8 to 20 carbon atoms, such as phthalic acid, isophthalic acid, terephthalic acid, and naphthalenedicarboxylic acid. Among these, alkenylene dicarboxylic acids having 4 to 20 carbon atoms and aromatic dicarboxylic acids having 8 to 20 carbon atoms are preferred.

Preferred examples of the trivalent or higher polycarboxylic acid (TC) include those having 3 to 8 valences or more, such as aromatic polycarboxylic acids. Preferred examples of the aromatic polycarboxylic acids include those having 9 to 20 carbon atoms, such as trimellitic acid and pyromellitic acid.

Examples of the polycarboxylic acid (PC) further include acid anhydrides and lower alkyl esters of any of the dicarboxylic acid (DIC), the trivalent or higher polycarboxylic acid (TC), and the mixture of the dicarboxylic acid (DIC) with the trivalent or higher polycarboxylic acid (TC). Specific examples of the lower alkyl esters include, but are not limited to, methyl ester, ethyl ester, and isopropyl ester.

The mass ratio (DIC:TC) between the dicarboxylic acid (DIC) and the trivalent or higher polycarboxylic acid (TC) in the mixture of the dicarboxylic acid (DIC) and the trivalent or higher polycarboxylic acid (TC) is not particularly limited and can be suitably selected to suit to a particular application, and is preferably 100:(0.01 to 10), more preferably 100:(0.01 to 1).

The mixing ratio between the polyol (PO) and the polycarboxylic acid (PC) at the polycondensation reaction is not particularly limited and can be suitably selected to suit to a particular application. The equivalent ratio ([OH]/[COOH]) of hydroxyl groups [OH] in the polyol (PO) to carboxyl groups [COOH] in the polycarboxylic acid (PC) is preferably from 2/1 to 1/1, more preferably from 1.5/1 to 1/1, and particularly preferably from 1.3/1 to 1.02/1.

The proportion of the polyol (PO) in the isocyanate-group-containing polyester prepolymer (A) is not particularly limited and can be suitably selected to suit to a particular application. The proportion is preferably from 0.5% to 40% by mass, more preferably from 1% to 30% by mass, and particularly preferably from 2% to 20% by mass. When the proportion is 0.5% by mass or more, deterioration of hot offset resistance is suppressed, and it becomes easy to achieve both heat-resistant storage stability and low-temperature fixability of the toner. When the proportion is 40% by mass or less, low-temperature fixability is improved.

The polyisocyanate (PIC) is not particularly limited and can be suitably selected to suit to a particular application. Specific examples thereof include, but are not limited to, aliphatic polyisocyanates, alicyclic polyisocyanates, aromatic diisocyanates, araliphatic diisocyanates, isocyanurates, phenol derivatives thereof, and those blocked with oxime or caprolactam.

Specific examples of the aliphatic polyisocyanates include, but are not limited to, tetramethylene diisocyanate, hexamethylene diisocyanate, 2,6-diisocyanatomethylcaproate, octamethylene diisocyanate, decamethylene diisocyanate, dodecamethylene diisocyanate, tetradecamethylene diisocyanate, trimethylhexane diisocyanate, and tetramethylhexane diisocyanate. Specific examples of the alicyclic polyisocyanates include, but are not limited to, isophorone diisocyanate and cyclohexylmethane diisocyanate. Specific examples of the aromatic diisocyanates include, but are not limited to, tolylene diisocyanate, diphenylmethane diisocyanate, 1,5-naphthylene diisocyanate, diphenylene-4,4′-diisocyanate, 4,4′-diisocyanato-3,3′-dimethyldiphenyl, 3-methyldiphenylmethane-4,4′-diisocyanate, and diphenyl ether-4,4′-diisocyanate. Specific examples of the araliphatic diisocyanates include, but are not limited to, α,α,α′,α′-tetramethylxylylene diisocyanate. Specific examples of the isocyanurates include, but are not limited to, tris-isocyanatoalkyl-isocyanurate and triisocyanatocycloalkyl-isocyanurate. Each of these can be used alone or in combination with others.

As to the mixing ratio between the polyisocyanate (PIC) and the active-hydrogen-group-containing polyester (e.g., hydroxyl-group-containing polyester), the mixing equivalent ratio ([NCO]/[OH]) of isocyanate groups [NCO] in the polyisocyanate (PIC) to hydroxyl groups [OH] in the hydroxyl-group-containing polyester is preferably from 5/1 to 1/1, more preferably from 4/1 to 1.2/1, and particularly preferably from 3/1 to 1.5/1. When the mixing equivalent ratio is 5/1 or less, low-temperature fixability is improved. When the mixing equivalent ratio is 1/1 or more, deterioration of offset resistance is suppressed.

The proportion of the polyisocyanate (PIC) in the isocyanate-group-containing polyester prepolymer (A) is not particularly limited and can be suitably selected to suit to a particular application. The proportion is preferably from 0.5% to 40% by mass, more preferably from 1% to 30% by mass, and particularly preferably from 2% to 20% by mass. When the proportion is 0.5% by mass or more, deterioration of hot offset resistance is suppressed, and it becomes easy to achieve both heat-resistant storage stability and low-temperature fixability of the toner. When the proportion is 40% by mass or less, low-temperature fixability is improved.

The average number of isocyanate groups included in one molecule of the isocyanate-group-containing polyester prepolymer (A) is preferably 1 or more, more preferably from 1.2 to 5, and most preferably from 1.5 to 4. When the average number of isocyanate groups is 1 or more, a decrease of the molecular weight of the polyester (RMPE) modified with a urea-bond-forming group is suppressed, and deterioration of hot offset resistance is suppressed.

The weight average molecular weight (Mw) of the polymer reactive with the active-hydrogen-group-containing compound is preferably from 3,000 to 40,000, more preferably from 4,000 to 30,000, when determined from a molecular weight distribution of tetrahydrofuran (THF)-soluble matter obtained by GPC (gel permeation chromatography). When the weight average molecular weight (Mw) is 3,000 or more, deterioration of heat-resistant storage stability is suppressed. When the weight average molecular weight (Mw) is 40,000 or less, deterioration of low-temperature fixability is suppressed.

The molecular weight distribution can be measured by gel permeation chromatography (GPC) as follows. First, columns are stabilized in a heat chamber at 40° C. Tetrahydrofuran (THF) as a solvent is let to flow in the columns at that temperature at a flow rate of 1 ml per minute, and 50 to 200 μl of a tetrahydrofuran solution of a resin having a sample concentration of from 0.05% to 0.6% by mass is injected therein. The molecular weight of the sample is determined by comparing the molecular weight distribution of the sample with a calibration curve that had been compiled with several types of monodisperse polystyrene standard samples, showing the relation between the logarithmic values of molecular weights and the number of counts. The polystyrene standard samples are those having respective molecular weights of 6×10², 2.1×10², 4×10², 1.75×10⁴, 1.1×10⁵, 3.9×10⁵, 8.6×10⁵, 2×10⁶, and 4.48×10⁶ (products of Pressure Chemical Co. or Toyo Soda Manufacturing Co., Ltd.). It is preferable that at least 10 polystyrene standard samples are used. As a detector, a refractive index (RI) detector can be used.

The urea-modified polyester can be used in combination with not only unmodified polyesters but also polyesters modified with a chemical bond other than urea bond, such as urethane-bond-modified polyesters.

When the toner composition contains a modified polyester such as urea-modified polyester, the modified polyester can be produced by a one-shot method.

One example method for producing a urea-modified polyester is described below.

First, a polyol and a polycarboxylic acid are heated to 150-280° C. in the presence of a catalyst (e.g., tetrabutoxy titanate, dibutyltin oxide), while reducing pressure and removing by-product water if necessary, to obtain a polyester having a hydroxyl group. Next, the polyester having a hydroxyl group is made to react with a polyisocyanate at 40-140° C. to obtain a polyester prepolymer having an isocyanate group. The polyester prepolymer having an isocyanate group is made to react with an amine at 0-140° C. to obtain a urea-modified polyester. The number average molecular weight of the urea-modified polyester is preferably from 1,000 to 10,000, more preferably from 1,500 to 6,000.

When the polyester having a hydroxyl group is made to react with a polyisocyanate and/or when the polyester prepolymer having an isocyanate group is made to react with an amine, a solvent can be used if necessary.

Specific examples of the solvent include, but are not limited to, those inactive against isocyanate group, such as aromatic solvents (e.g., toluene, xylene), ketones (e.g., acetone, methyl ethyl ketone, methyl isobutyl ketone), esters (e.g., ethyl acetate), amides (e.g., dimethylformamide, dimethylacetamide), and ethers (e.g., tetrahydrofuran). When using an unmodified polyester in combination, a polyester produced in the same manner as the polyester having a hydroxyl group may be mixed in the solution of the urea-modified polyester after the reaction.

### Crystalline Polyester

The toner base particles of the present disclosure may contain a crystalline polyester as a binder resin having ester bond. The crystalline polyester is obtained by a reaction between an alcohol component and an acid component, and is a polyester having at least a melting point. Preferred examples of the crystalline polyester include, but are not limited to, crystalline polyesters obtained by a reaction between alcohol components (e.g., saturated aliphatic diol compounds having 2 to 12 carbon atoms, such as 1,4-butanediol, 1,6-hexanediol, 1,8-octanediol, 1,10-decanediol, 1,12-dodecanediol, and derivatives thereof) and dicarboxylic acid components (e.g., dicarboxylic acids having C═C double bonds and 2 to 12 carbon atoms, and saturated dicarboxylic acids having 2 to 12 carbon atoms, such as fumaric acid, 1,4-butanedioic acid, 1,6-hexanedioic acid, 1,8-octanedioic acid, 1,10-decanedioic acid, 1,12-dodecanedioic acid, and derivatives thereof).

Use of the crystalline polyester suppresses contamination of carriers and charging members with wax (release agent) present at the surface of the toner base particles, while maintaining and without deteriorating the releasing function at the time of fixing the toner.

The content of the crystalline polyester in 100 parts by mass of the toner base particles is preferably from 1 to 30 parts by mass. When the content is 1 part by mass or more, deterioration of low-temperature fixability is suppressed. When the content is 30 parts by mass or less, the amount of crystalline polyester present at the outermost surface of the toner does not become too large, a decrease of image quality caused by contamination of photoconductor and/or other members is suppressed, and a decrease of the developer fluidity and/or image density is suppressed. In addition, deterioration of the toner surface properties is suppressed, carriers are suppressed from being contaminated and becoming unable to maintain sufficient chargeability for a long period of time, and inhibition of environmental stability is suppressed.

In the present disclosure, the oil phase may contain, as binder resin components, any combination of non-crystalline polyesters (e.g., unmodified polyesters, modified polyesters), crystalline polyesters, and binder resin precursors. The oil phase may further contain other binder resin components.

When polyester is contained as one binder resin component, it is preferable that the proportion of the polyester in the binder resin components be 50% by mass or more. When the proportion of the polyester is 50% by mass or more, deterioration of low-temperature fixability is prevented. It is particularly preferable that all of the binder resin components be polyester.

Binder Resin Components Other than Polyester

Specific examples of the binder resin components other than polyester include, but are not limited to: polymers of styrene or styrene substitution products, such as polystyrene, poly(p-chlorostyrene), and polyvinyl toluene; styrene copolymers, such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl-a-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleate copolymer; and polymethyl methacrylate, polybutyl methacrylate, polyvinyl chloride, polyvinyl acetate, polyethylene, polypropylene, epoxy resin, epoxy polyol resin, polyurethane, polyamide, polyvinyl butyral, polyacrylic acid, rosin, modified rosin, terpene resin, aliphatic or alicyclic hydrocarbon resin, aromatic petroleum resin, chlorinated paraffin, and paraffin wax.

### Colorant

The colorant is not particularly limited and may be suitably selected from known dyes and pigments to suit to a particular application. Specific examples of the colorant include, but are not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarin Lake, Thioindigo Red B, Thioindigo Maroon, Oil Red, Quinacridone Red, Pyrazolone Red, polyazo red, Chrome Vermilion, Benzidine Orange, perinone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. Each of these can be used alone or in combination with others.

The amount of the colorant in the toner is not particularly limited and can be suitably selected to suit to a particular application. The proportion of the colorant in the toner base particles is preferably from 1% to 15% by mass, and more preferably from 3% to 10% by mass. When the proportion is 1% by mass or more, a decrease of coloring power of the toner is suppressed. When the proportion is 15% by mass or less, defective dispersion of the colorant in the toner is suppressed, and deterioration of coloring power and electric properties of the toner is suppressed.

In the case of mixing a resin particle dispersion, an inorganic filler dispersion, a colorant dispersion, and a release agent dispersion, the proportion of the colorant in the colorant dispersion is preferably 50% by mass or less, and more preferably from 2% to 40% by mass.

The colorant may be combined with a resin to become a master batch. The resin used for the master batch is not particularly limited and can be suitably selected from known ones to suit to a particular application. Specific examples thereof include, but are not limited to, polyester, polymers of styrene or substitution products thereof, styrene copolymers, polymethyl methacrylate, polybutyl methacrylate, polyvinyl chloride, polyvinyl acetate, polyethylene, polypropylene, epoxy resin, epoxy polyol resin, polyurethane, polyamide, polyvinyl butyral, polyacrylic acid resin, rosin, modified rosin, terpene resin, aliphatic hydrocarbon resin, alicyclic hydrocarbon resin, aromatic petroleum resin, chlorinated paraffin, and paraffin wax. Each of these can be used alone or in combination with others.

Specific examples of the polymers of styrene or substitution products thereof include, but are not limited to, polystyrene, poly(p-chlorostyrene), and polyvinyl toluene. Specific examples of the styrene copolymers include, but are not limited to, styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl-a-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleate copolymer.

The master batch can be produced by mixing or kneading the resin and the colorant under application of a high shearing force. To increase the interaction between the colorant and the resin, an organic solvent may be added. Alternatively, the master batch may be obtained by a method called flushing that produces a wet cake of the colorant, which can be used as it is without being dried.

In the flushing method, an aqueous paste of the colorant is mixed or kneaded with the resin and the organic solvent so that the colorant is transferred to the resin side, followed by removal of the organic solvent and moisture. Preferably, the mixing or kneading is performed by a high shearing dispersing device such as a three roll mill.

### Surfactant

In an oil phase/water phase method, it is preferable to use a dispersant in the process of emulsification or dispersion, for stabilizing oil droplets and narrowing the particle size distribution while achieving a desired shape. The dispersant is not particularly limited and can be suitably selected to suit to a particular application. Specific examples thereof include, but are not limited to, surfactants, poorly-water-soluble inorganic compound dispersants, and polymeric protection colloids. Each of these can be used alone or in combination with others. Among these, surfactants are preferred. Examples of anionic surfactants are described below.

Examples of the surfactants further include anionic surfactants, cationic surfactants, and nonionic surfactants used for emulsion aggregation methods to be described later.

Specific examples of the anionic surfactants include, but are not limited to, alkylbenzene sulfonates, α-olefin sulfonates, and phosphates. In particular, anionic surfactants having a fluoroalkyl groups are preferred.

Specific examples of the anionic surfactants having a fluoroalkyl group include, but are not limited to, fluoroalkyl carboxylic acids having 2 to 10 carbon atoms (hereinafter “C2-C10”) and metal salts thereof, disodium perfluorooctanesulfonylglutamate, sodium 3-[ω-fluoroalkyl(C6-C11)oxy]-1-alkyl(C3-C4)sulfonate, sodium 3-[ω-fluoroalkanoyl(C6-C8)-N-ethylamino]-1-propanesulfonate, fluoroalkyl(C11-C20) carboxylic acids and metal salts thereof, perfluoroalkylcarboxylic acids (C7-C13) and metal salts thereof, perfluoroalkyl(C4-C12) sulfonic acids and metal salts thereof, perfluorooctanesulfonic acid diethanolamide, N-propyl-N-(2-hydroxyethyl)perfluorooctane sulfonamide, perfluoroalkyl(C6-C10)sulfonamide propyltrimethylammonium salt, perfluoroalkyl(C6-C10)-N-ethylsulfonylglycine salt, and monoperfluoroalkyl(C6-C16) ethyl phosphate.

Specific examples of commercially-available products of the anionic surfactants having a fluoroalkyl group include, but are not limited to, SURFLON S-111, S-112, and S-113 (products of Asahi Glass Co., Ltd.); FLUORAD FC-93, FC-95, FC-98, and FC-129 (products of Sumitomo 3M Limited); UNIDYNE DS-101 and DS-102 (products of DAIKIN INDUSTRIES, LTD.); MEGAFACE F-110, F-120, F-113, F-191, F-812, and F-833 (products of Dainippon Ink and Chemicals, Incorporated); EFTOP EF-102, 103, 104, 105, 112, 123A, 123B, 306A, 501, 201, and 204 (products of Tohkem Products Corporation); and FTERGENT F-100 and F-150 (products of NEOS COMPANY LIMITED).

Specific examples of the polymeric protection colloids include, but are not limited to, homopolymers and copolymers of acids, (meth)acrylic monomers having hydroxyl group, vinyl alcohols and ethers thereof, esters of vinyl alcohols with carboxyl-group-containing compounds, amide compounds and methylol compounds thereof, chlorides, and/or compounds containing nitrogen atom or heterocyclic ring thereof; polyoxyethylenes; and celluloses.

Specific examples of the acids include, but are not limited to, acrylic acid, methacrylic acid, α-cyanoacrylic acid, α-cyanomethacrylic acid, itaconic acid, crotonic acid, fumaric acid, maleic acid, and maleic anhydride.

Specific examples of the (meth)acrylic monomers having hydroxyl group include, but are not limited to, β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acrylamide, and N-methylol methacrylamide.

Specific examples of the vinyl alcohols and ethers thereof include, but are not limited to, vinyl methyl ether, vinyl ethyl ether, and vinyl propyl ether.

Specific examples of the esters of vinyl alcohols with carboxyl-group-containing compounds include, but are not limited to, vinyl acetate, vinyl propionate, and vinyl butyrate.

Specific examples of the amide compounds and methylol compounds thereof include, but are not limited to, acrylamide, methacrylamide, and diacetone acrylamide, and methylol compounds thereof.

Specific examples of the chlorides include, but are not limited to, acrylic acid chloride and methacrylic acid chloride.

Specific examples of the compounds containing nitrogen atom or heterocyclic ring thereof include, but are not limited to, vinylpyridine, vinylpyrrolidone, vinylimidazole, and ethyleneimine.

Specific examples of the polyoxyethylenes include, but are not limited to, polyoxyethylene, polyoxypropylene, polyoxyethylene alkylamine, polyoxypropylene alkylamine, polyoxyethylene alkylamide, polyoxypropylene alkylamide, polyoxyethylene nonylphenyl ether, polyoxyethylene lauryl phenyl ether, polyoxyethylene stearyl phenyl ester, and polyoxyethylene nonyl phenyl ester.

Specific examples of the celluloses include, but are not limited to, methyl cellulose, hydroxyethyl cellulose, and hydroxypropyl cellulose.

When a dispersion stabilizer which is soluble in acids and alkalis, such as calcium phosphate, is used, the calcium phosphate can be removed from the particles by dissolving with an acid (e.g., hydrochloric acid) and washing with water, or decomposing with an enzyme.

### Release Agent

The release agent is not particularly limited and can be suitably selected to suit to a particular application, but those having a low melting point of from 50° C. to 120° C. are preferred. A release agent having a low melting point, when dispersed in the resin, works effectively between a fixing roller and the toner, whereby hot offset resistance is improved even in an oilless system (in which a fixing roller is not applied with any release agent such as oil).

Preferred examples of the release agent include, but are not limited to, waxes. Specific examples of the waxes include, but are not limited to, natural waxes such as plant waxes (e.g., carnauba wax, cotton wax, sumac wax, rice wax), animal waxes (e.g., beeswax, lanolin), mineral waxes (e.g., ozokerite, ceresin), and petroleum waxes (e.g., paraffin, microcrystalline, petrolatum). In addition to these natural waxes, synthetic hydrocarbon waxes (e.g., Fischer-Tropsch wax, polyethylene wax) and synthetic waxes (e.g., ester, ketone, ether) may also be used. Furthermore, the following materials may also be used: fatty acid amides such as 12-hydroxystearic acid amide, stearic acid amide, phthalic anhydride imide, and chlorinated hydrocarbon; homopolymers and copolymers of polyacrylates (e.g., poly-n-stearyl methacrylate, poly-n-lauryl methacrylate), which are low-molecular-weight crystalline polymers, such as copolymer of n-stearyl acrylate and ethyl methacrylate; and crystalline polymers having a long alkyl group on a side chain. Each of these can be used alone or in combination with others.

The melting point of the release agent is not particularly limited and can be suitably selected to suit to a particular application, but is preferably from 50° C. to 120° C., more preferably from 60° C. to 90° C. When the melting point is 50° C. or higher, the release agent is prevented from adversely affecting heat-resistant storage stability. When the melting point is 120° C. or lower, the occurrence of cold offset is prevented when fixing the toner at a low temperature.

The melt viscosity of the release agent is preferably from 5 to 1,000 cps, more preferably from 10 to 100 cps, when measured at a temperature 20° C. higher than the melting point of the release agent. When the melt viscosity is 5 cps or higher, deterioration of releasability is suppressed. When the melt viscosity is 1,000 cps or higher, hot offset resistance and low-temperature fixability are improved.

The amount of the release agent in the toner is not particularly limited and can be suitably selected to suit to a particular application. In particular, the proportion of the release agent in the toner base particles is preferably 40% by mass or less, and more preferably from 3% to 30% by mass. When the proportion is 40% by mass or less, deterioration of toner fluidity is suppressed.

### Fluidity Improving Agent

Toner components may further include a fluidity improving agent in addition to the toner base particle and the external additive. The fluidity improving agent is a surface treatment agent for the toner components (e.g. toner base particle) that increases hydrophobicity to prevent deterioration of fluidity and chargeability even under high humidity conditions. Specific examples of the fluidity improving agent include, but are not limited to, silane coupling agents, silylation agents, silane coupling agents having a fluorinated alkyl group, organic titanate coupling agents, aluminum coupling agents, silicone oils, and modified silicone oils. Preferably, particles of silica and titanium oxide are surface-treated with such a fluidity improving agent to become hydrophobic silica and hydrophobic titanium oxide, respectively.

### Cleanability Improving Agent

The cleanability improving agent is an additive that facilitates removal of toner remaining on a photoconductor or primary transfer medium after image transfer. Specific examples thereof include, but are not limited to, metal salts of fatty acids (e.g., zinc stearate, calcium stearate), and fine particles of polymers (e.g., polymethyl methacrylate, polystyrene) produced by soap-free emulsion polymerization. Preferably, the particle size distribution of the fine particles of polymers is as narrow as possible. More preferably, the volume average particle diameter thereof is in the range of from 0.01 to 1 μm.

### Magnetic Material

The magnetic material is used to the extent that chargeability of the toner is not impaired. Specific examples thereof include, but are not limited to, metals (e.g., ferrite, magnetite, reduced iron, cobalt, manganese, nickel), alloys thereof, and compounds containing these metals.

Lubricant Specific examples of the lubricant include, but are not limited to, fatty acid amides (e.g., ethylenebis stearamide, oleamide) and fatty acid metal salts (e.g., zinc stearate, calcium stearate).

### Abrasive

Specific examples of the abrasive include, but are not limited to, silica, alumina, and cerium oxide.

The content of these other components is generally very small so as not to impair the effect of the present invention. Specifically, the proportion thereof in the toner base particles is preferably from 0.1% to 2% by mass, more preferably from 0.2% to 1% by mass.

### External Additive

The toner of the present disclosure contains toner particles each containing a toner base particle and an external additive. The external additive is mixed with the toner base particles using, for example, a HENSCHEL MIXER, to be adhered to the toner base particles.

Examples of the external additive include inorganic fine particles and organic fine particles. The inorganic fine particles are used as the external additives for imparting fluidity, developability, and chargeability to the toner particles. The inorganic fine particles and organic fine particles can be used as fluidity aids or cleaning aids.

The inorganic fine particles are not particularly limited and suitably selected from known ones to suit to a particular application. Specific examples thereof include, but are not limited to, fine particles of silica, alumina, titanium oxide, barium titanate, magnesium titanate, calcium titanate, strontium titanate, zinc oxide, tin oxide, quartz sand, clay, mica, sand-lime, diatomaceous earth, chromium oxide, cerium oxide, red iron oxide, antimony trioxide, magnesium oxide, zirconium oxide, barium sulfate, barium carbonate, calcium carbonate, magnesium carbonate, silicon carbide, silicon nitride, and tricalcium phosphate. Each of these can be used alone or in combination with others.

Specific examples of the organic fine particles include, but are not limited to, all particles which are usually added to the surface of toner, such as vinyl resin, polyester, and silicone resin.

The amount of addition of the external additive can be appropriately varied. For example, it is preferable to add 0.1 to 7 parts by mass of the external additive to 100 parts by mass of the toner base particles.

### Toner Production Method

A method for producing toner base particles of the toner of the present disclosure can be suitably selected to suit to a particular application. Examples thereof include pulverization methods and polymerization methods. Examples of the polymerization methods include methods called oil phase/water phase methods in which an oil phase is dissolved or dispersed in a water phase, such as emulsion aggregation methods and dissolution suspension method. In particular, dissolution suspension methods are suitable.

Preferably, the toner base particles of the present disclosure are produced by dispersing an oil phase in an aqueous medium (i.e., water phase), where the oil phase is obtained by dissolving or dispersing toner materials including at least a polyester and/or binder resin precursor (e.g., modified polyester), a colorant, and a release agent in an organic solvent, and removing the organic solvent from the resulted oil phase/water phase (“O/W”) dispersion. More preferably, the O/W dispersion (i.e., emulsion dispersion) is obtained by, after dissolving an active-hydrogen-group-containing compound and a polymer reactive with the active-hydrogen-group-containing compound in the oil phase, dispersing the oil phase in the water phase composed of the aqueous medium in which a fine particle dispersant is present. Further preferably, the binder resin components are subjected to a cross-linking reaction and/or elongation reaction in the emulsion dispersion.

That is, the toner base particles are preferably produced by: dispersing a solution or dispersion containing an organic solvent, an active-hydrogen-group-containing compound capable of producing a modified polyester having at least ester bond and a bonding unit other than the ester bond in its molecular structure, and a polymer reactive with the active-hydrogen-group-containing compound, to prepare an emulsion dispersion; subjecting the active-hydrogen-group-containing compound and the polymer to a cross-linking reaction and/or elongation reaction in the emulsion dispersion; and removing the organic solvent from the emulsion dispersion. Further preferably, the binder resin and/or binder resin precursor contains a resin material selected from crystalline polyester and non-crystalline polyester.

Hereinafter, raw materials and production methods for the toner base particles of the toner of the present disclosure are described with reference to specific examples, but embodiments of the present invention are not limited thereto. Hereinafter, oil phase/water phase methods in which an oil phase is dissolved or dispersed in a water phase, such as emulsion aggregation methods and dissolution suspension method, are described with reference to specific examples.

The method for producing the toner base particles of the present disclosure is not particularly limited and can be suitably selected to suit to a particular application. Examples thereof include pulverization methods and polymerization methods. Examples of the polymerization methods include methods called oil phase/water phase methods in which an oil phase is dissolved or dispersed in a water phase, such as emulsion aggregation methods and dissolution suspension method. In particular, dissolution suspension methods are suitable for obtaining a toner whose particle diameter and Dv/Dn are both small.

Each production method is specifically described below.

### Pulverization Method

The pulverization method is a method for obtaining toner base particles by charging a mixture of toner materials into a melt-kneader, followed by melt-kneading, pulverizing, and classifying of the mixture.

In the pulverization method, for the purpose of adjusting the average circularity of the toner, the shapes of the resulted toner base particles may be controlled by applying a mechanical impact force thereto. In this case, the mechanical impact force may be applied using a device such as a HYBRIDIZER and a MECHANO FUSION.

Specific examples of the oil phase/water phase method for granulation in which an oil phase containing toner material is dispersed in a water phase composed of an aqueous medium include dissolution suspension methods and emulsion aggregation methods, and details of each of which are described below.

### Dissolution Suspension Method

In a method for producing toner base particles of the toner of the present disclosure, a solution or dispersion (i.e., oil phase), obtained by dissolving or dispersing toner materials including a binder resin or binder resin raw material and a colorant as main components in an organic solvent, is emulsified or dispersed in an aqueous medium (i.e., water phase) to prepare an emulsion or dispersion.

Preferably, in the method for producing toner base particles, a solution or dispersion (i.e., oil phase) of toner materials, including at least an active-hydrogen-group-containing compound and a polymer reactive with the active-hydrogen-group-containing compound, is emulsified or dispersed in an aqueous medium (i.e., water phase), and the active-hydrogen-group-containing compound and the polymer reactive with the active-hydrogen-group-containing compound are subjected to a reaction in the aqueous medium. Preferably, the reaction between the active-hydrogen-group-containing compound and the polymer reactive with the active-hydrogen-group-containing compound in the aqueous medium generates an adhesive base material (to be described later).

In particular, the toner base particles are preferably produced by: dispersing a solution or dispersion containing an organic solvent, an active-hydrogen-group-containing compound capable of producing a modified polyester having at least ester bond and a bonding unit other than the ester bond in its molecular structure, and a polymer reactive with the active-hydrogen-group-containing compound, to prepare an emulsion dispersion; subjecting the active-hydrogen-group-containing compound and the polymer to a cross-linking reaction and/or elongation reaction in the emulsion dispersion; and removing the organic solvent from the emulsion dispersion. The polymer resulted from a cross-linking reaction and/or elongation reaction between the active-hydrogen-group-containing compound and the polymer reactive with the active-hydrogen-group-containing compound is a modified polyester that has a function as an adhesive base material.

The solution or dispersion of toner materials is prepared by dissolving or dispersing the toner materials in an organic solvent. The toner materials are not particularly limited and can be suitably selected to suit to a particular application as long as they are capable of forming toner. For example, the toner materials contain either an active-hydrogen-group-containing compound or a polymer (prepolymer) reactive with the active-hydrogen-group-containing compound, and may further contain other components such as an unmodified polyester, a release agent, and a colorant, as necessary.

Preferably, the solution or dispersion of toner materials is prepared by dissolving or dispersing the toner materials in an organic solvent.

In the dissolution or dispersion step, to put the inorganic filler in a finely dispersed state, a disperser is preferably used. The disperser is not particularly limited, but examples thereof include high-speed rotary shear dispersers and media dispersers. In the method for producing toner particles of the present disclosure, a media disperser is particularly preferred for excellent ability for making materials fine. The media disperser has a mechanism of stirring minute beads made of metal or ceramic in a dispersion chamber, to finely disperse materials in the dispersion by collision between the beads.

Preferably, the organic solvent is removed during or after granulation of the toner.

The organic solvent that dissolves or disperses toner materials is not particularly limited and can be suitably selected to suit to a particular application as long as it is a solvent capable of dissolving or dispersing the toner materials. Preferably, the organic solvent is a volatile solvent having a boiling point of less than 150° C. for the ease of removal during or after granulation of the toner. Specific examples of the solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Further, ester solvents are preferred, and ethyl acetate is particularly preferred. Each of these can be used alone or in combination with others.

The amount of use of the organic solvent is not particularly limited and can be suitably selected to suit to a particular application. The amount of use of the organic solvent is preferably from 40 to 300 parts by mass, more preferably from 60 to 140 parts by mass, particularly preferably from 80 to 120 parts by mass, with respect to 100 parts by mass of toner materials. The solution or dispersion of toner materials may be prepared by dissolving or dispersing toner materials, such as an active-hydrogen-group-containing compound, a polymer reactive with the active-hydrogen-group-containing compound, an unmodified polyester, a release agent, a colorant, and a charge controlling agent, in an organic solvent.

The toner materials other than the polymer (prepolymer) reactive with the active-hydrogen-group-containing compound may be added to the aqueous medium in the process of preparing the aqueous medium (to be described later), or together with the solution or dispersion of toner materials when the solution or dispersion is added to the aqueous medium.

The aqueous medium is not particularly limited and can be suitably selected from known ones. Specific examples thereof include, but are not limited to, water, water-miscible solvents, and mixtures thereof. Among these, water is particularly preferred. The water-miscible solvent is not particularly limited as long as it is miscible with water. Specific examples thereof include, but are not limited to, alcohols, dimethylformamide, tetrahydrofuran, cellosolves, and lower ketones. Specific examples of the alcohols include, but are not limited to, methanol, isopropanol, and ethylene glycol. Specific examples of the lower ketones include, but are not limited to, acetone and methyl ethyl ketone. Each of these can be used alone or in combination with others.

Preferably, the solution or dispersion of toner materials is emulsified or dispersed in the aqueous medium by dispersing the solution or dispersion of toner materials in the aqueous medium under stirring. The method for dispersing is not particularly limited and can be suitably selected to suit to a particular application, and may be performed using a known disperser. Specific examples of the disperser include, but are not limited to, a low-speed shearing disperser and a high-speed shearing disperser. In this toner production method, in the process of emulsifying or dispersing, the active-hydrogen-group-containing compound and the polymer reactive with an active-hydrogen-group-containing compound are subjected to an elongation reaction and/or cross-linking reaction to form an adhesive base material (i.e., binder resin).

The organic solvent is removed from the emulsion slurry obtained by the emulsification or dispersion. The organic solvent may be removed by, for example, (1) a method of gradually raising the temperature of the entire reaction system to completely evaporate and remove the organic solvent from oil droplets, or (2) a method of spraying the emulsion dispersion into a dry atmosphere to completely remove a water-insoluble organic solvent from oil droplets to form toner fine particles and, at the same time, evaporating and removing an aqueous dispersant.

Upon removal of the organic solvent, toner base particles are formed. The toner base particles thus formed are subjected to washing and drying, and thereafter classification, as needed. The classification is performed by removing ultrafine particles by means of cyclone separator, decantation, or centrifugal separator. The classification operation may be performed after the toner base particles have been dried to become powder.

Next, an external additive is added to the surfaces of the toner base particles to obtain a toner.

### Emulsion Aggregation Method

An emulsion polymerization aggregation fusion method is known in which an oil phase containing toner materials, or a monomer phase, is dispersed and/or emulsified in an aqueous medium (water phase) to granulate toner base particles.

In the case of producing the toner base particles by the emulsion polymerization aggregation fusion method, it is easy to achieve targeted characteristics of the toner of the present disclosure. Specifically, it is easy to achieve targeted characteristics when the toner of the present disclosure is produced by the emulsion polymerization aggregation fusion method (abbreviated as “emulsion aggregation method”) in which a resin particle dispersion prepared by emulsion polymerization is subjected to hetero-aggregation together with dispersions of an inorganic filler (preferably a layered inorganic mineral at least part of which is modified with an organic ion), a colorant, a release agent, etc., followed by fusion and coalescence.

The emulsion polymerization aggregation fusion method involves an aggregation step and a fusion step. The aggregation step is a step of preparing an aggregated particle dispersion by mixing a resin particle dispersion prepared by emulsion polymerization, an inorganic filler, a colorant dispersion, and, if necessary, a release agent dispersion, to aggregate the resin particles, the inorganic filler, and the colorant to form aggregated particles. The fusion step is a step of forming toner particles by heating and fusing the aggregated particles.

In the aggregation step, the resin particle dispersion, the inorganic filler, the colorant dispersion, and, if necessary, the release agent dispersion, are mixed with each other, to aggregate the resin particles and the like to form aggregated particles. The aggregated particles may be formed by hetero-aggregation. At that time, for the purpose of stabilizing the aggregated particles and controlling the particle diameter and/or particle size distribution, an ionic surfactant having a polarity different from that of the aggregated particles, or a compound having one or more valences of charge, such as metal salt, may be added. In the fusion step, the aggregated particles are heated to a temperature equal to or higher than the glass transition temperature of the resin, to be melted.

In the first stage of the fusion step, an adhesion step may be provided in which another fine particle dispersion is mixed in the aggregated particle dispersion to make the fine particles uniformly adhere to the surfaces of the aggregated particles to form adhered particles. Further, another adhesion step may be provided in which an inorganic filler dispersion is mixed in the aggregated particle dispersion to make the inorganic filler uniformly adhere to the surfaces of the aggregated particles to form adhered particles.

Further, to strengthen the adhesion of the inorganic filler, after the step of adhering the inorganic filler, another adhesion step may be provided in which another fine particle dispersion is mixed therein to make the fine particles uniformly adhere to the surfaces of the aggregated particles to form adhered particles. These adhered particles are formed by hetero-aggregation. This adhered particle dispersion is also heated to a temperature equal to or higher than the glass transition temperature of the resin particles in the same manner as described above, to be fused to form fused particles.

The fused particles fused in the fusion step are present as a colored fusion particle dispersion in the aqueous medium. The fused particles are taken out from the aqueous medium in a washing step, and at the same time, impurities having been mixed in each step are removed. The fused particles are then dried to obtain toner base particles as powder.

In the washing step, acidic or basic water in an amount several times of that of the fused particles is added and stirred, then solid contents are obtained by filtration. Pure water in an amount several times as much as the solid contents is then added and stirred, followed by filtration. These processes are repeated several times until the pH of the filtered solution reaches about 7 after the filtration, to obtain colored toner particles. In the drying step, the toner particles obtained in the washing step are dried at a temperature below the glass transition temperature. At this time, circulation of dry air, or heating under vacuum conditions may be performed, as necessary.

Next, an external additive is added to the surfaces of the toner base particles having been dried, to obtain a toner.

In the present disclosure, to stabilize the resin particle dispersion, the colorant dispersion, and the release agent dispersion, an alicyclic compound of an organic acid metal salt can be used as it is as an emulsifier. However, if these dispersions are not always stable under basic conditions due to pH of the colorant dispersion and the release agent dispersion, or for temporal stability of the resin particle dispersion, a small amount of surfactant can be used.

Specific examples of the surfactant include, but are not limited to: anionic surfactants such as sulfates, sulfonates, phosphates, and soaps; cationic surfactants such as amine salts and quaternary ammonium salts; and nonionic surfactants such as polyethylene glycols, alkylphenol ethylene oxide adducts, and polyols.

Among these, ionic surfactants are preferred, and anionic surfactants and cationic surfactants are more preferred. Since anionic surfactants generally have a strong dispersing power and well disperse resin particles and colorants, cationic surfactants are advantageous for dispersing the release agent in the toner of the present disclosure. Preferably, nonionic surfactants are used in combination with anionic surfactants or cationic surfactants. Each of these surfactants can be used alone or in combination with others.

Specific examples of the anionic surfactants include, but are not limited to: fatty acid soaps such as potassium laurate, sodium oleate, and sodium castor oil; sulfates such as octyl sulfate, lauryl sulfate, lauryl ether sulfate, and nonyl phenyl ether sulfate; sulfonates such as sodium alkylnaphthalene sulfonates (e.g., lauryl sulfonate, dodecylbenzene sulfonate, triisopropylnaphthalene sulfonate, dibutylnaphthalene sulfonate), naphthalene sulfonate formalin condensates, monooctyl sulfosuccinate, dioctyl sulfosuccinate, lauramide sulfonate, and oleamide sulfonate; phosphates such as lauryl phosphate, isopropyl phosphate, and nonyl phenyl ether phosphate; and dialkyl sulfosuccinates (e.g., sodium dioctyl sulfosuccinate) and sulfosuccinates (e.g., disodium lauryl sulfosuccinate).

Specific examples of the cationic surfactants include, but are not limited to: amine salts such as laurylamine hydrochloride, stearylamine hydrochloride, oleylamine acetate, stearylamine acetate, and stearylaminopropylamine acetate; and quaternary ammonium salts such as lauryltrimethylammonium chloride, dilauryldimethylammonium chloride, distearylammonium chloride, distearyldimethylammonium chloride, lauryldihydroxyethylmethylammonium chloride, oleylbispolyoxyethylenemethylammonium chloride, lauroylaminopropyldimethylethylammonium ethosulfate, lauroylaminopropyldimethylhydroxyethylammonium perchlorate, alkylbenzenedimethylammonium chloride, and alkyltrimethylammonium chloride.

Specific examples of the nonionic surfactants include, but are not limited to: alkyl ethers such as polyoxyethylene octyl ether, polyoxyethylene lauryl ether, polyoxyethylene stearyl ether, and polyoxyethylene oleyl ether; alkylphenyl ethers such as polyoxyethylene octyl phenyl ether and polyoxyethylene nonyl phenyl ether; alkyl esters such as polyoxyethylene laurate, polyoxyethylene stearate, and polyoxyethylene oleate; alkylamines such as polyoxyethylene lauryl amino ether, polyoxyethylene stearyl amino ether, polyoxyethylene oleyl amino ether, polyoxyethylene soybean amino ether, and polyoxyethylene beef tallow amino ether; alkylamides such as polyoxyethylene lauramide, polyoxyethylene stearamide, and polyoxyethylene oleamide; vegetable oil ethers such as polyoxyethylene castor oil ether and polyoxyethylene rapeseed oil ether; alkanolamides such as lauric acid diethanolamide, stearic acid diethanolamide, and oleic acid diethanolamide; and sorbitan ester ethers such as polyoxyethylene sorbitan monolaurate, polyoxyethylene sorbitan monopalmitate, polyoxyethylene sorbitan monostearate, and polyoxyethylene sorbitan monooleate.

The proportion of the surfactant in each dispersion is generally very small so as not to impair the effect of the present invention. Specifically, the proportion thereof in the resin particle dispersion is preferably from 0.01% to 1% by mass, more preferably from 0.02% to 0.5% by mass, and most preferably from 0.1% to 0.2% by mass. When the proportion is 0.01% by mass or more, the occurrence of aggregation is suppressed especially when the pH of the resin particle dispersion is not sufficiently basic.

The proportion of the surfactant in the colorant dispersion and the release agent dispersion is preferably from 0.01% to 10% by mass, more preferably from 0.1% to 5% by mass, and most preferably from 0.5% to 0.2% by mass. Since the stability of each particle differs from each other at the time of aggregation, when the proportion is 0.01% by mass or more, liberation of specific particles is suppressed. When the proportion is 10% by mass or less, disadvantages such as a wide particle size distribution and difficulty in controlling the particle diameter can be avoided.

In the present disclosure, an aqueous medium is used as a dispersion medium for the resin particle dispersion, the inorganic filler dispersion, the colorant dispersion, the release agent dispersion, and dispersions of other components. Specific examples of the aqueous medium include, but are not limited to, water such as distilled water and ion-exchange water, and alcohols. Each of these can be used alone or in combination with others.

In the step of preparing the aggregated particle dispersion, the emulsifying power of the emulsifier may be adjusted by pH to cause aggregation and adjust the aggregated particles. At the same time, an aggregating agent may be added to obtain aggregated particles having a narrower particle size distribution in a stable and rapid manner.

Preferred examples of the aggregating agent include compounds having one or more valences of charge such as: water-soluble surfactants such as the above-described ionic surfactants and nonionic surfactants; acids such as hydrochloric acid, sulfuric acid, nitric acid, acetic acid, and oxalic acid; metal salts of inorganic acids, such as magnesium chloride, sodium chloride, aluminum sulfate, calcium sulfate, ammonium sulfate, aluminum nitrate, silver nitrate, copper sulfate, and sodium carbonate; metal salts of aliphatic acids and aromatic acids, such as sodium acetate, potassium formate, sodium oxalate, sodium phthalate, and potassium salicylate; metal salts of phenols, such as sodium phenolate; metal salts of amino acids; and inorganic acid salts of aliphatic or aromatic amines, such as triethanolamine hydrochloride and aniline hydrochloride. For stability of the aggregated particles, stability of the aggregating agent with respect to heat and time, and removability during washing, metal salts of inorganic acids are preferred in terms of performance and application.

The amount of addition of the aggregating agent varies depending on the valence of electric charge, but is generally small. When the valence is 1, the proportion is preferably 3% by mass or less. When the valence is 2, the proportion is preferably 1% by mass or less. When the valence is 3, the proportion is preferably 0.5% by mass or less. The amount of addition of the aggregating agent is preferably small as much as possible. Compounds having a high valence are preferred because the amount of addition of the aggregating agent can be reduced.

### Developer

The developer of the present disclosure may be either a one-component developer composed of the toner of the present disclosure or a two-component developer composed of the toner of the present disclosure and a carrier. To be used for a high-speed printer corresponding to a recent improvement in information processing speed, the two-component developer is more preferred for extending the lifespan of the printer. The two-component developer of the present disclosure is characterized by comprising the toner of the present disclosure. The carrier contained in the developer is not particularly limited.

### Carrier

The carrier is not particularly limited and can be suitably selected to suit to a particular application, but the carrier preferably comprises a core material and a resin layer covering the core material.

The core material is not particularly limited. Examples thereof include, but are not limited to, manganese-strontium (Mn-Sr) materials, manganese-magnesium (Mn-Mg) materials, iron powder, magnetite, copper-zinc (Cu-Zn) materials. The material of the resin layer is not particularly limited and can be suitably selected from known resins to suit to a particular application.

### Toner Accommodating Unit

In the present disclosure, a toner accommodating unit refers to a unit having a function of accommodating toner and accommodating the toner. The toner accommodating unit may be in the form of, for example, a toner accommodating container, a developing device, or a process cartridge.

The toner accommodating container refers to a container accommodating the toner.

The developing device refers to a device that accommodates toner and is configured to develop an electrostatic latent image into a toner image with the toner.

The process cartridge refers to a combined body of an image bearer with a developing unit accommodating the toner, detachably mountable on an image forming apparatus. The process cartridge may further include at least one of a charger, an irradiator, and a cleaner.

When the toner accommodating unit of the present disclosure is mounted on an image forming apparatus, an image is formed with the toner of the present disclosure without causing background stains, while providing excellent low-temperature fixability and a stable charging ability that prevents in-machine contamination cause by toner scattering.

### Image Forming Apparatus and Image Forming Method

An image forming method of the present disclosure includes: an electrostatic latent image forming process (including a charging process and an irradiating process) in which an electrostatic latent image is formed on an electrostatic latent image bearer; a developing process in which the electrostatic latent image is developed with the toner of the present disclosure to form a visible image; a transfer process in which the visible image is transferred onto a recording medium; and a fixing process in which the visible image is fixed on the recording medium. The image forming method may further include other processes such as a neutralization process, a cleaning process, a recycle process, and a control process, if needed.

An image forming apparatus of the present disclosure includes: an electrostatic latent image bearer; an electrostatic latent image forming device (including a charger and an irradiator) configured to form an electrostatic latent image on the electrostatic latent image bearer; a developing device containing the toner of the present disclosure, configured to develop the electrostatic latent image with the toner to form a visible image; a transfer device configured to transfer the visible image onto a recording medium; and a fixing device configured to fix the visible image on the recording medium. The image forming apparatus may further include other devices such as a neutralizer, a cleaner, a recycler, and a controller, if needed.

The toner of the present disclosure has a sufficiently high charging ability, forms an image with less background stains, does not scatter in machines, and exhibits low-temperature fixability. Therefore, the image forming method and image forming apparatus of the present disclosure are able to respond to the demand of high speed and high reliability, and to provide high quality images without generating abnormal images.

### Electrostatic Latent Image Forming Process and Electrostatic Latent Image Forming Device

The electrostatic latent image forming process is a process in which an electrostatic latent image is formed on an electrostatic latent image bearer.

The electrostatic latent image bearer (also referred to as “electrophotographic photoconductor” or “photoconductor”) is not limited in material, shape, structure, and size, and can be appropriately selected from known materials. As the shape, drum-like shape is preferred. Specific examples of the materials include, but are not limited to, inorganic photoconductors such as amorphous silicon and selenium, and organic photoconductors (OPC) such as polysilane and phthalopolymethine. Among these, organic photoconductors (OPC) are preferred for producing images with a higher definition.

The formation of the electrostatic latent image can be conducted by, for example, uniformly charging a surface of the electrostatic latent image bearer and irradiating the surface with light containing image information by the electrostatic latent image forming device.

The electrostatic latent image forming device may include at least a charger to uniformly charge a surface of the electrostatic latent image bearer and an irradiator to irradiate the surface of the electrostatic latent image bearer with light containing image information.

The charging can be conducted by, for example, applying a voltage to a surface of the electrostatic latent image bearer by the charger.

The charger is not particularly limited and can be suitably selected to suit to a particular application. Specific examples thereof include, but are not limited to, contact chargers equipped with a conductive or semiconductive roller, brush, film, or rubber blade and non-contact chargers employing corona discharge such as corotron and scorotron.

Preferably, the charger is disposed in or out of contact with the electrostatic latent image bearer and configured to charge the surface of the electrostatic latent image bearer by applying direct-current and alternating-current voltages in superimposition thereto.

Preferably, the charger is a charging roller disposed close to but out of contact with the electrostatic latent image bearer via a gap tape and configured to charge the surface of the electrostatic latent image bearer by applying direct-current and alternating-current voltages in superimposition thereto.

The irradiation can be conducted by, for example, irradiating the surface of the electrostatic latent image bearer with light containing image information by the irradiator.

The irradiator is not particularly limited and can be suitably selected to suit to a particular application as long as it can irradiate the surface of the electrostatic latent image bearer charged by the charger with light containing information of an image to be formed.

Specific examples thereof include, but are not limited to, various irradiators of radiation optical system type, rod lens array type, laser optical type, and liquid crystal shutter optical type.

The irradiation can also be conducted by irradiating the back surface of the electrostatic latent image bearer with light containing image information.

### Developing Process and Developing Device

The developing process is a process in which the electrostatic latent image is developed with the toner to form a visible image.

The visible image can be formed by developing the electrostatic latent image with the toner by the developing device.

Preferably, the developing device includes a developing unit storing the toner and is configured to apply the toner to the electrostatic latent image by contacting or without contacting the electrostatic latent image. More preferably, the developing unit is equipped with a container containing the toner.

The developing device may be either a monochrome developing device or a multicolor developing device. Preferably, the developing device includes a stirrer that frictionally stirs and charges the toner and a rotatable magnet roller.

In the developing device, toner particles and carrier particles are mixed and stirred. The toner particles are charged by friction and retained on the surface of the rotating magnet roller, thus forming magnetic brush. The magnet roller is disposed proximity to the electrostatic latent image bearer (photoconductor), so that a part of the toner particles composing the magnetic brush formed on the surface of the magnet roller are moved to the surface of the electrostatic latent image bearer (photoconductor) by an electric attractive force. As a result, the electrostatic latent image is developed with the toner particles and a visible image is formed with the toner particles on the surface of the electrostatic latent image bearer (photoconductor).

### Transfer Process and Transfer Device

The transfer process is a process in which the visible image is transferred onto a recording medium. It is preferable that the visible image is primarily transferred onto an intermediate transferor and then secondarily transferred onto the recording medium. Specifically, the transfer process includes a primary transfer process in which the visible image formed with two or more toners with different colors, preferably in full colors, is transferred onto the intermediate transferor to form a composite transferred image, and a secondary transfer process in which the composite transferred image is transferred onto the recording medium.

In the transfer process, the visible image may be transferred by charging the electrostatic latent image bearer (photoconductor) by a transfer charger. The transfer process can be performed by the transfer device. Preferably, the transfer device includes a primary transfer device to transfer the visible image onto an intermediate transferor to form a composite transfer image, and a secondary transfer device to transfer the composite transfer image onto a recording medium.

The intermediate transferor is not particularly limited and can be suitably selected from known transferors to suit to a particular application. Preferred examples thereof include, but are not limited to, a transfer belt.

The transfer device (including the primary transfer device and the secondary transfer device) preferably includes a transferrer configured to separate the visible image formed on the electrostatic latent image bearer (photoconductor) to the recording medium side by charging. The number of the transfer devices is at least one, and may be two or more.

Specific examples of the transferrer include, but are not limited to, a corona transferrer utilizing corona discharge, a transfer belt, a transfer roller, a pressure transfer roller, and an adhesive transferrer.

The recording medium is not limited to any particular material and conventional recording media (recording paper) can be used.

### Fixing Process and Fixing Device

The fixing process is a process in which a visible image transferred onto the recording medium is fixed thereon by the fixing device. The fixing process may be conducted every time each color developer is transferred onto the recording medium. Alternatively, the fixing process may be conducted at once after all color developers are superimposed on one another on the recording medium.

The fixing device is not particularly limited and can be suitably selected to suit to a particular application, but preferably includes a heat-pressure member. Specific examples of the heat-pressure member include, but are not limited to, a combination of a heat roller and a pressure roller; and a combination of a heat roller, a pressure roller, and an endless belt.

Preferably, the fixing device includes a heater equipped with a heat generator, a film in contact with the heater, and a pressurizer pressed against the heater via the film, and is configured to allow a recording medium having an unfixed image thereon to pass through between the film and the pressurizer so that the unfixed image is fixed on the recoding medium by application of heat. The heating temperature of the heat-pressure member is preferably from 80° C. to 200° C.

The fixing device may be used together with or replaced with an optical fixer according to the purpose.

### Other Processes and Other Devices

The neutralization process is a process in which a neutralization bias is applied to the electrostatic latent image bearer to neutralize the electrostatic latent image bearer, and is preferably conducted by a neutralizer.

The neutralizer is not particularly limited and can be appropriately selected from known neutralizers as long as it is capable of applying a neutralization bias to the electrostatic latent image bearer. Preferred examples thereof include, but are not limited to, a neutralization lamp.

The cleaning process is a process in which residual toner particles remaining on the electrostatic latent image bearer are removed, and is preferably conducted by a cleaner.

The cleaner is not particularly limited and can be appropriately selected from known cleaners as long as it is capable of removing residual toner particles remaining on the electrostatic latent image bearer. Preferred examples thereof include, but are not limited to, magnetic brush cleaner, electrostatic brush cleaner, magnetic roller cleaner, blade cleaner, brush cleaner, and web cleaner.

The recycle process is a process in which the toner particles removed in the cleaning process are recycled for the developing device, and is preferably conducted by a recycler. The recycler is not particularly limited. Specific examples thereof include, but are not limited to, a conveyor.

The control process is a process in which the above-described processes are controlled, and is preferably conducted by a controller.

The controller is not particularly limited and can be suitably selected to suit to a particular application as long as it is capable of controlling the above-described processes. Specific examples of the controller include, but are not limited to, a sequencer and a computer.

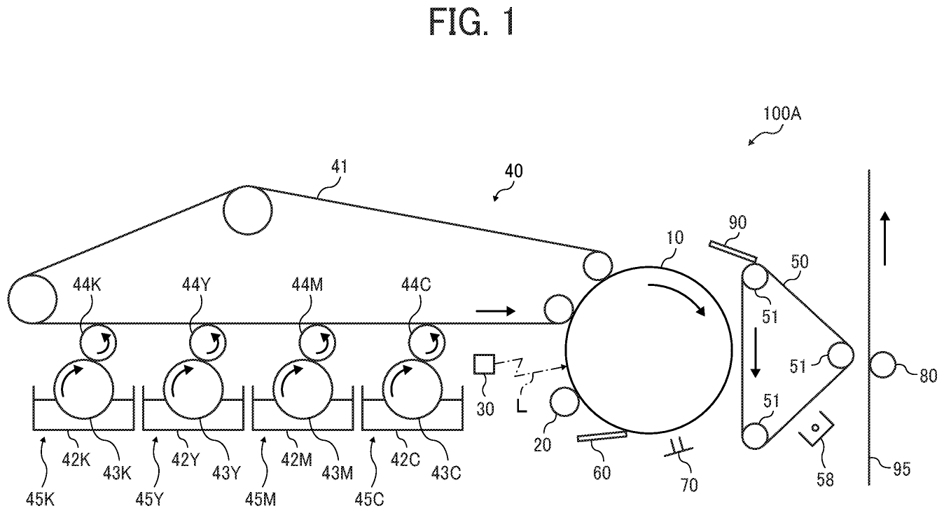

FIG. 1 is a schematic view illustrating a first example of the image forming apparatus according to an embodiment of the present invention. An image forming apparatus 100A includes a photoconductor drum 10, a charging roller 20, an irradiator 30, a developing device 40, an intermediate transfer belt 50, a cleaner 60 having a cleaning blade, and a neutralization lamp 70.

The intermediate transfer belt 50 is in the form of an endless belt and is stretched taut by three rollers 51 disposed inside the loop of the endless belt. The intermediate transfer belt 50 is movable in the direction indicated by arrow in FIG. 1. One or two of the three rollers 51 also function(s) as transfer bias roller(s) capable of applying a transfer bias (primary transfer bias) to the intermediate transfer belt 50. A cleaner 90 having a cleaning blade is disposed in the vicinity of the intermediate transfer belt 50. A transfer roller 80 capable of applying a transfer bias (secondary transfer bias) to a transfer sheet 95, for transferring the toner image thereon, is disposed facing the intermediate transfer belt 50. Around the intermediate transfer belt 50, a corona charger 58 that gives charge to the toner image transferred onto the intermediate transfer belt 50 is disposed between a contact portion of the intermediate transfer belt 50 with the photoconductor drum 10 and another contact portion of the intermediate transfer belt 50 with the transfer sheet 95 in the direction of rotation of the intermediate transfer belt 50.

The developing device 40 includes a developing belt 41, and a black developing unit 45K, a yellow developing unit 45Y, a magenta developing unit 45M, and a cyan developing unit 45C each disposed around the developing belt 41. The black, yellow, magenta, and cyan developing units 45K, 45Y, 45M, and 45C include respective developer containers 42K, 42Y, 42M, and 42C, respective developer supplying rollers 43K, 43Y, 43M, and 43C, and respective developing rollers (developer bearers) 44K, 44Y, 44M, and 44C. The developing belt 41 is in the form of an endless belt and stretched taut by multiple belt rollers. The developing belt 41 is movable in the direction indicated by arrow in FIG. 1. A part of the developing belt 41 is in contact with the photoconductor drum 10.

An image forming operation performed by the image forming apparatus 100A is described below. First, the charging roller 20 uniformly charges a surface of the photoconductor drum 10 and the irradiator 30 irradiates the surface of the photoconductor drum 10 with light L to form an electrostatic latent image. The electrostatic latent image formed on the photoconductor drum 10 is developed with toner supplied from the developing device 40 to form a toner image. The toner image formed on the photoconductor drum 10 is primarily transferred onto the intermediate transfer belt 50 by a transfer bias applied from the roller(s) 51 and then secondarily transferred onto the transfer sheet 95 by a transfer bias applied from the transfer roller 80. After the toner image has been transferred onto the intermediate transfer belt 50, the surface of the photoconductor drum 10 is cleaned by removing residual toner particles by the cleaner 60 and then neutralized by the neutralization lamp 70.

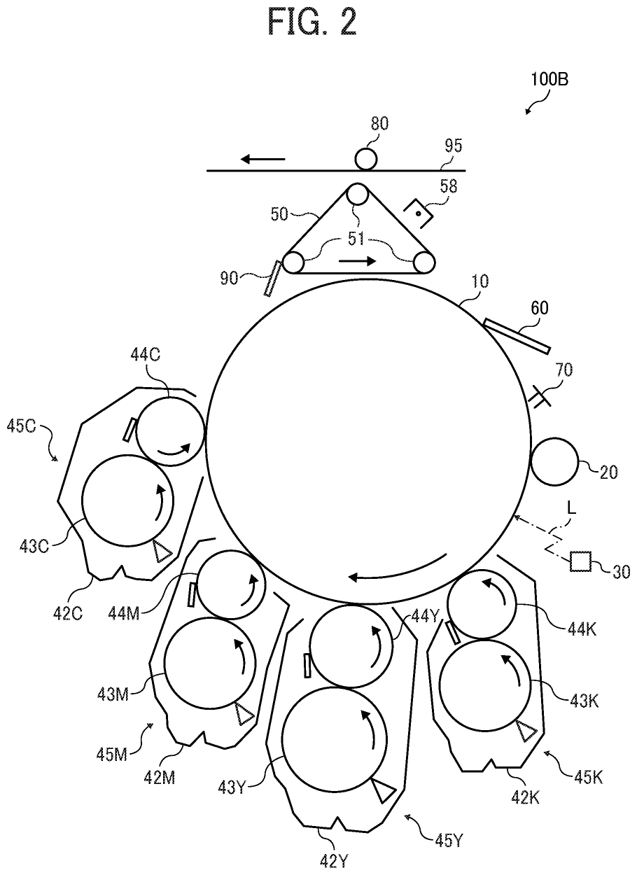

FIG. 2 is a schematic view of a second example of the image forming apparatus according to an embodiment of the present invention. An image forming apparatus 100B has a similar configuration to the image forming apparatus 100A except that the developing belt 41 is omitted and the black developing unit 45K, the yellow developing unit 45Y, the magenta developing unit 45M, and the cyan developing unit 45C are disposed facing the circumferential surface of the photoconductor drum 10.

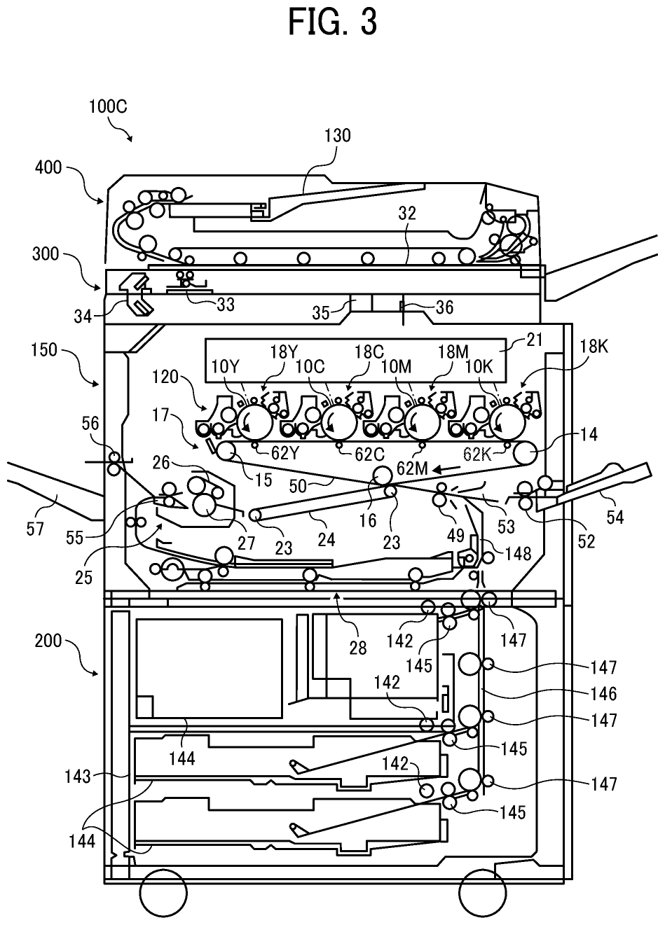

FIG. 3 is a schematic view of a third example of the image forming apparatus according to an embodiment of the present invention. An image forming apparatus 100C is a tandem-type full-color image forming apparatus which includes a copier main body 150, a sheet feeding table 200, a scanner 300, and an automatic document feeder (ADF) 400.

An intermediate transfer belt 50, disposed at the center of the copier main body 150, is in the form of an endless belt and stretched taut by three rollers 14, 15, and 16. The intermediate transfer belt 50 is movable in the direction indicated by arrow in FIG. 3. In the vicinity of the roller 15, a cleaner 17 having a cleaning blade is disposed that removes residual toner particles remaining on the intermediate transfer belt 50 from which the toner image has been transferred onto a recording sheet. Four image forming units 18Y, 18C, 18M, and 18K for respectively forming yellow, cyan, magenta, and black images are arranged in tandem along the conveyance direction and facing a part of the intermediate transfer belt 50 stretched between the support rollers 14 and 15, thus forming a tandem unit 120.

In the vicinity of the tandem unit 120, an irradiator 21 is disposed. On the opposite side of the tandem unit 120 relative to the intermediate transfer belt 50, a secondary transfer belt 24 is disposed. The secondary transfer belt 24 is in the form of an endless belt and stretched taut with a pair of rollers 23. A recording sheet conveyed onto the secondary transfer belt 24 is brought into contact with the intermediate transfer belt 50 at between the rollers 16 and 23.

In the vicinity of the secondary transfer belt 24, a fixing device 25 is disposed. The fixing device 25 includes a fixing belt 26 and a pressing roller 27. The fixing belt 26 is in the form of an endless belt and stretched taut between a pair of rollers. The pressing roller 27 is pressed against the fixing belt 26. In the vicinity of the secondary transfer belt 24 and the fixing device 25, a sheet reversing device 28 is disposed for reversing the recording sheet so that images can be formed on both surfaces of the recording sheet.

A full-color image forming operation performed by the image forming apparatus 100C is described below. First, a document is set on a document table 130 of the automatic document feeder 400. Alternatively, a document is set on a contact glass 32 of the scanner 300 while the automatic document feeder 400 is lifted up, followed by holding down of the automatic document feeder 400.

As a start switch is pressed, in a case in which the document is set on the automatic document feeder 400, the scanner 300 starts driving after the document is moved onto the contact glass 32. On the other hand, in a case in which the document is set on the contact glass 32, the scanner 300 immediately starts driving. A first traveling body 33 equipped with a light source and a second traveling body 34 equipped with a mirror then start traveling. The first traveling body 33 directs light to the document and the second traveling body 34 reflects light reflected from the document toward a reading sensor 36 through an imaging lens 35. Thus, the document is read by the reading sensor 36 and converted into image information of yellow, magenta, cyan, and black.

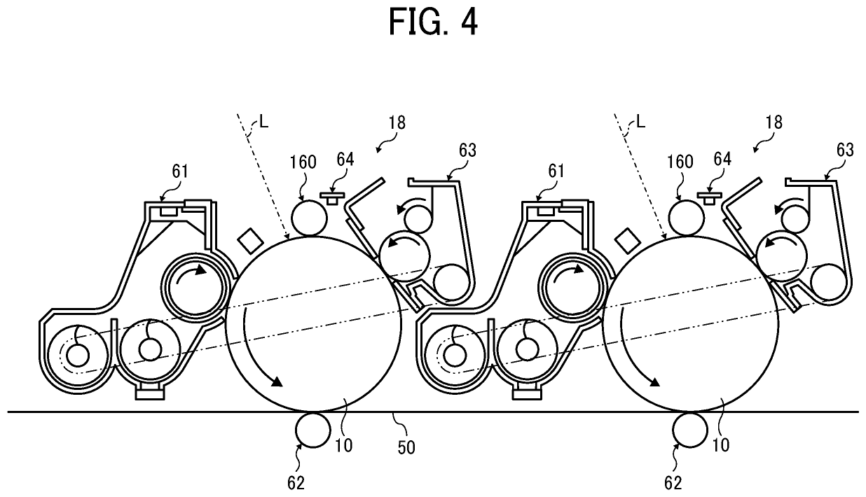

The image information of each color is transmitted to the corresponding image forming unit 18Y, 18C, 18M, or 18K to form a toner image of each color. Referring to FIG. 4, each image forming unit 18 includes a photoconductor drum 10, a charging roller 160 to uniformly charge the photoconductor drum 10, a developing device 61 to develop an electrostatic latent image formed on the photoconductor drum 10 into a toner image with a developer of each color, a transfer roller 62 to transfer the toner image onto the intermediate transfer belt 50, a cleaner 63 having a cleaning blade, and a neutralization lamp 64.

The toner images formed in the image forming unit 18Y, 18C, 18M, and 18K are primarily transferred in a successive and overlapping manner onto the intermediate transfer belt 50 stretched and moved by the rollers 14, 15, and 16. Thus, a composite toner image is formed on the intermediate transfer belt 50.

At the same time, in the sheet feeding table 200, one of sheet feed rollers 142 starts rotating to feed recording sheets from one of sheet feed cassettes 144 in a sheet bank 143. One of separation rollers 145 separates the recording sheets one by one and feeds them to a sheet feed path 146. Feed rollers 147 feed each sheet to a sheet feed path 148 in the copier main body 150. The sheet is stopped by striking a registration roller 49. Alternatively, recording sheets may be fed from a manual feed tray 54. In this case, a separation roller 52 separates the sheets one by one and feeds it to a manual sheet feeding path 53. The sheet is stopped upon striking the registration roller 49. The registration roller 49 is generally grounded. Alternatively, the registration roller 49 may be applied with a bias for the purpose of removing paper powders from the sheet.

The registration roller 49 starts rotating in synchronization with an entry of the composite toner image formed on the intermediate transfer belt 50 to between the intermediate transfer belt 50 and the secondary transfer belt 24, so that the recording sheet is fed thereto and the composite toner image can be secondarily transferred onto the recording sheet. Residual toner particles remaining on the intermediate transfer belt 50 after the composite toner image has been transferred are removed by the cleaner 17.

The recording sheet having the composite toner image thereon is fed by the secondary transfer belt 24 to the fixing device 25, and the composite toner image is fixed on the recording sheet. A switch claw 55 switches sheet feed paths so that the recording sheet is ejected by an ejection roller 56 and stacked on a sheet ejection tray 57. Alternatively, the switch claw 55 may switch sheet feed paths so that the recording sheet is introduced into the sheet reversing device 28 and gets reversed. After another image is formed on the back side of the recording sheet, the recording sheet is ejected by the ejection roller 56 on the sheet ejection tray 57.

### EXAMPLES

Further understanding can be obtained by reference to certain specific examples which are provided herein for the purpose of illustration only and are not intended to be limiting. In the following descriptions, “parts” represents “parts by mass” unless otherwise specified.

### Example 1

### Production of Toner

### Production of Toner Base Particles A

### Synthesis of Crystalline Polyester

In a 5-liter four-neck flask equipped with a nitrogen introducing tube, a dewatering tube, a stirrer, and a thermocouple, 2,300 g of 1,6-alkanediol, 2,530 g of fumaric acid, 291 g of trimellitic anhydride, and 4.9 g of hydroquinone were put, and allowed to react at 160° C. for 5 hours, thereafter at 200° C. for 1 hour, and further under a pressure of 8.3 kPa for 1 hour. Thus, a crystalline polyester 1 was prepared.

### Synthesis of Non-Crystalline Polyester (Low-Molecular Polyester)

In a 5-liter four-necked flask equipped with a nitrogen introducing tube, a dewatering tube, a stirrer, and a thermocouple, 229 parts of ethylene oxide 2-mol adduct of bisphenol A, 529 parts of propylene oxide 3-mol adduct of bisphenol A, 208 parts of terephthalic acid, 46 parts of adipic acid, and 2 parts of dibutyltin oxide were put, and allowed to react at 230° C. under normal pressure for 7 hours and subsequently under reduced pressures of from 10 to 15 mmHg for 4 hours. Further, 44 parts of trimellitic anhydride were put in the flask and allowed to react at 180° C. under normal pressure for 2 hours. Thus, a non-crystalline polyester 1 was prepared. Here, the non-crystalline polyester 1 corresponds to an unmodified polyester.

### Synthesis of Polyester Prepolymer

In a reaction vessel equipped with a condenser tube, a stirrer, and a nitrogen introducing tube, 682 parts of ethylene oxide 2-mol adduct of bisphenol A, 81 parts of propylene oxide 2-mol adduct of bisphenol A, 283 parts of terephthalic acid, 22 parts of trimellitic anhydride, and 2 parts of dibutyltin oxide were put, and allowed to react at 230° C. under normal pressure for 8 hours and subsequently under reduced pressures of from 10 to 15 mmHg for 5 hours. Thus, an intermediate polyester 1 was prepared. The intermediate polyester 1 was found to have a number average molecular weight Mn of 2,100, a weight average molecular weight Mw of 9,500, a glass transition temperature Tg of 55° C., an acid value of 0.5 KOHmg/g, and a hydroxyl value of 51 KOHmg/g. Here, the intermediate polyester 1 corresponds to an unmodified polyester.

Next, in a reaction vessel equipped with a condenser tube, a stirrer, and a nitrogen introducing tube, 410 parts of the intermediate polyester 1, 89 parts of isophorone diisocyanate, and 500 parts of ethyl acetate were put, and allowed to react at 100° C. for 5 hours. Thus, a prepolymer 1 was prepared. Here, the prepolymer 1 is a modified polyester corresponding to the “active-hydrogen-group-containing compound”.

### Synthesis of Ketimine

In a reaction vessel equipped with a stirrer and a thermometer, 170 parts of isophoronediamine and 75 parts of methyl ethyl ketone were put and allowed to react at 50° C. for 5 hours. Thus, a ketimine compound 1 was prepared. The ketimine compound 1 was found to have an amine value of 418. Here, the ketimine compound 1 corresponds to the “polymer reactive with an active-hydrogen-group-containing compound”.

### Preparation of Master Batch

First, 1,200 parts of water, 540 parts of a carbon black (PRINTEX 35 product of Degussa AG, having a DBP oil absorption of 42 ml/100 mg and a pH of 9.5), and 1,200 parts of the non-crystalline polyester 1 were mixed by a HENSCHEL MIXER (product of Mitsui Mining Co., Ltd.). The mixture was kneaded by a double roll at 150° C. for 30 minutes, then rolled to cool, and pulverized by a pulverizer. Thus, a master batch 1 was prepared.

### Preparation of Oil Phase

In a reaction vessel equipped with a stirrer and a thermometer, 378 parts of the non-crystalline polyester 1, 110 parts of a carnauba wax, 10 parts of an inorganic filler (trimethylstearylammonium-modified montmorillonite), and 947 parts of ethyl acetate were put, heated to 80° C. under stirring, kept at 80° C. for 5 hours, and cooled to 30° C. over a period of 1 hour. Next, 500 parts of the master batch 1 and 500 parts of ethyl acetate were put in the vessel and mixed for 1 hour. Thus, a raw material liquid 1 was prepared.

The raw material liquid 1 in an amount of 1,324 parts was transferred to another vessel and subjected to a dispersion treatment for the carbon black, the wax, and the inorganic filler 12 times (12 passes) using a bead mill (ULTRAVISCOMILL, product of AIMEX CO., LTD.) filled with 80% by volume of zirconia beads having a diameter of 0.5 mm at a liquid feeding speed of 1 kg/hour and a disc peripheral speed of 6 m/sec. Next, 1,042.3 parts of a 65% ethyl acetate solution of the non-crystalline polyester 1 were added, and the raw material liquid was subjected to the dispersion treatment using the bead mill under the above-described conditions once (1 pass). Thus, a pigment-wax-inorganic-filler dispersion 1 was prepared. The solid content concentration (130° C., 30 minutes) of the pigment-wax-inorganic-filler dispersion 1 was 50%.

### Preparation of Crystalline Polyester Dispersion

In a 2-liter metallic vessel, 100 g of the crystalline polyester resin 1 and 400 g of ethyl acetate were put, then heat-melted at 75° C., and rapidly cooled at a rate of 27° C./min in an ice water bath. After adding 500 ml of glass beads (having a diameter of 3 mm) to the vessel, a pulverization treatment was performed by a batch-type sand mill (product of Kanpe Hapio Co., Ltd.) for 10 hours. Thus, a crystalline polyester dispersion 1 was prepared.

### Synthesis of Fine Organic Particle Emulsion

In a reaction vessel equipped with a stirrer and a thermometer, 683 parts of water, 11 parts of a sodium salt of a sulfate of ethylene oxide adduct of methacrylic acid (ELEMINOL RS-30, product of Sanyo Chemical Industries, Ltd.), 138 parts of styrene, 138 parts of methacrylic acid, and 1 part of ammonium persulfate were put and stirred at a revolution of 400 rpm for 15 minutes. Thus, a white emulsion was prepared. The white emulsion was heated to 75° C. and subjected to a reaction for 5 hours. A 1% aqueous solution of ammonium persulfate in an amount of 30 parts was further added to the emulsion, and the emulsion was aged at 75° C. for 5 hours. Thus, a fine particle dispersion 1 was prepared, which was an aqueous dispersion of a vinyl resin (i.e., a copolymer of styrene, methacrylic acid, and a sodium salt of a sulfate of ethylene oxide adduct of methacrylic acid). The volume average particle diameter of the fine particle dispersion 1 was 0.14 μm when measured by an instrument LA-920. A part of the fine particle dispersion 1 was dried to isolate the resin component.

### Preparation of Water Phase

A water phase 1 was prepared by stir-mixing 990 parts of water, 83 parts of the fine particle dispersion 1, 37 parts of a 48.5% aqueous solution of sodium dodecyl diphenyl ether disulfonate (ELEMINOL MON-7, product of Sanyo Chemical Industries, Ltd.), and 90 parts of ethyl acetate. The water phase was a milky white liquid.

### Emulsification and Solvent Removal

In a vessel, 664 parts of the pigment-wax-inorganic-filler dispersion 1, 109.4 parts of the prepolymer 1, 120.1 parts of the crystalline polyester dispersion 1, and 4.6 parts of the ketimine compound 1 were put and mixed using a TK HOMOMIXER (product of Tokushu Kika Kogyo Co., Ltd.) at a revolution of 5,000 rpm for 1 minute. Further, 1,200 parts of the water phase 1 were added to the vessel and mixed using a TK HOMOMIXER at a revolution of 8,000 rpm for 60 seconds. Thus, an emulsion slurry 1 was prepared.

The emulsion slurry 1 was put in a vessel equipped with a stirrer and a thermometer and subjected to solvent removal at 30° C. for 8 hours and subsequently to aging at 45° C. for 4 hours. Thus, a dispersion slurry 1 was prepared.

### Washing and Drying

After 100 parts of the dispersion slurry 1 was filtered under reduced pressures, the following operations were carried out.

(1) 100 parts of ion-exchange water were added to the resulted filter cake and mixed using a TK HOMOMIXER (at a revolution of 12,000 rpm for 10 minutes), followed by filtration;

(2) 100 parts of a 10% aqueous solution of sodium hydroxide were added to the filter cake of (1) and mixed using a TK HOMOMIXER (at a revolution of 12,000 rpm for 30 minutes), followed by filtration under reduced pressures;

(3) 100 parts of a 10% aqueous solution of hydrochloric acid were added to the filter cake of (2) and mixed using a TK HOMOMIXER (at a revolution of 12,000 rpm for 10 minutes, followed by filtration;

(4) 300 parts of ion-exchange water were added to the filter cake of (3) and mixed using a TK HOMOMIXER (at a revolution of 12,000 rpm for 10 minutes), followed by filtration. This operation was repeated twice, thus obtaining a filter cake 1.

The filter cake 1 was dried by a circulating air dryer at 45° C. for 48 hours and then filtered with a mesh having an opening of 75 m. Thus, toner base particles A were prepared.

### External Addition Treatment

Next, 100 parts by mass of the toner base particles A were mixed with 0.6 parts by mass of silica particles (H1303VP having an average primary diameter of 23 nm, product of Clariant) and 1.0 part by mass of titanium oxide (JMT-1501B having an average particle diameter of 20 nm, product of TAYCA Corporation) by a HENSCHEL MIXER.

As to the mixing order, only the silica particles were added and mixed in the first stage, and the titanium oxide was added and mixed in the second stage. After the mixing, the mixture was let to pass through a sieve having an opening of 500 mesh. Thus, a toner 1 was obtained.

### Example 2

A toner 2 was prepared in the same manner as in Example 1 except that the number of times of dispersion treatment for the pigment-wax-inorganic-filler dispersion 1 was changed to 6 passes.

### Example 3

A toner 3 was prepared in the same manner as in Example 1 except that the amount of addition of the inorganic filler (trimethylstearylammonium-modified montmorillonite) to the oil phase was changed to 5 parts.

### Example 4

A toner 4 was prepared in the same manner as in Example 1 except that the amount of addition of the inorganic filler (trimethylstearylammonium-modified montmorillonite) to the oil phase was changed to 25 parts and the number of times of dispersion treatment for the pigment-wax-inorganic-filler dispersion 1 was changed to 18 passes.

### Example 5

A toner 5 was prepared in the same manner as in Example 1 except that the type of the inorganic filler was changed to a dimethylstearylbenzylammonium-modified bentonite.

### Example 6

A toner 6 was prepared in the same manner as in Example 1 except that the type of the inorganic filler was changed to kaolin clay.

### Example 7

A toner 7 was prepared in the same manner as in Example 1 except that the type of the inorganic filler was changed to barium sulfate.

### Example 8

A toner 8 was prepared in the same manner as in Example 1 except that the type of the inorganic filler was changed to barium sulfate, the amount of the inorganic filler was changed to 30 parts, and the number of times of dispersion treatment for the pigment-wax-inorganic-filler dispersion 1 was changed to 18 passes.

### Example 9

First, 30 parts of styrene were mixed with 15 parts of carbon black and 0.25 parts of 2,2′-azobisisobutyronitrile. After nitrogen gas substitution, the mixture was heated at 80° C. for 6 hours. After cooling, 92 parts of styrene and 53 parts of n-butyl methacrylate were added and dissolved uniformly. To this carbon black dispersion, 10 parts of a carnauba wax and 5 parts of an inorganic filler (i.e., trimethylstearylammonium-modified montmorillonite) were added and dispersed using a ball mill for 40 hours. To 40 parts of this dispersion, 1 part of 2,2′-azobis(2,4-dimethylvaleronitrile) was added. Thus, an oil phase was prepared.

On the other hand, a water phase was prepared by dissolving 6 parts of calcium phosphate and 10 parts of sodium dodecylbenzenesulfonate in 160 parts of ion-exchange water.

Next, the oil phase was added to the water phase and dispersed using a TK HOMOMIXER (product of Tokushu Kika Kogyo Co., Ltd.) at 4,000 rpm for 10 minutes. The resulted mixture was then transferred to a separable flask equipped with a stirrer, a condenser tube, and a thermometer. After nitrogen gas substitution, the mixture was heated and stirred at 60° C. for 8 hours. After polymerization, washing with water was performed 3 times by vacuum filtration and then vacuum dried at 40° C. Thus, a toner 9 was prepared.

### Comparative Example 1

A toner 10 was prepared in the same manner as in Example 1 except that the number of times of dispersion treatment for the pigment-wax-inorganic-filler dispersion 1 was changed to 2 passes.

### Comparative Example 2

A toner 11 was prepared in the same manner as in Example 1 except that the amount of addition of the inorganic filler (trimethylstearylammonium-modified montmorillonite) to the oil phase was changed to 25 parts and the number of times of dispersion treatment for the pigment-wax-inorganic-filler dispersion 1 was changed to 2 passes.

### Comparative Example 3

A toner 12 was prepared in the same manner as in Example 1 except that the amount of addition of the inorganic filler (trimethylstearylammonium-modified montmorillonite) to the oil phase was changed to 2 parts.

### Comparative Example 4

A toner 13 was prepared in the same manner as in Example 1 except that the amount of addition of the inorganic filler (trimethylstearylammonium-modified montmorillonite) to the oil phase was changed to 80 parts and the number of times of dispersion treatment for the pigment-wax-inorganic-filler dispersion 1 was changed to 18 passes.

### Comparative Example 5

A toner 14 was prepared in the same manner as in Example 1 except that the amount of addition of the 48.5% aqueous solution of sodium dodecyl diphenyl ether disulfonate (ELEMINOL MON-7, product of Sanyo Chemical Industries, Ltd.) to the water phase was changed to 13 parts.

### Comparative Example 6

A toner 15 was prepared in the same manner as in Example 1 except that the amount of addition of the inorganic filler (trimethylstearylammonium-modified montmorillonite) to the oil phase was changed to 1 part and the number of times of dispersion treatment for the pigment-wax-inorganic-filler dispersion 1 was changed to 24 passes.

### Comparative Example 7

A toner 16 was prepared in the same manner as in Example 1 except that the amount of addition of the inorganic filler (trimethylstearylammonium-modified montmorillonite) to the oil phase was changed to 80 parts and the number of times of dispersion treatment for the pigment-wax-inorganic-filler dispersion 1 was changed to 48 passes.

Properties of the toners 1 to 16 prepared in the above Examples and Comparative Examples are shown in Table 1. The measurement procedures were as follows.

### Measurements

### S2/S1 and Standard Deviation SD

First, to observe the inorganic filler at the surface of the toner base particle of each of the toners 1 to 16, the external additive adhering to the toner base particle was removed by the following method to isolate the toner base particle.

(1) In a 200-mL ointment bottle, 100 mL of ion-exchange water and 4.4 mL of a 33% by mass aqueous solution of DRIWEL (product of FUJIFILM Corporation) containing a surfactant were put; then 5 g of toner were added to the resulted mixed solution, mixed well by shaking the bottle 30 times, and left to stand for 1 hour or more.

(2) Next, after shaking the bottle 20 times to stir the toner, ultrasonic waves were applied for 2 minutes using an ultrasonic homogenizer (HOMOGENIZER, model VCX750, CV33, product of Sonics & Materials, Inc.) setting an output dial to 50% under the following conditions to disperse the toner.

Ultrasonic Conditions
Vibration time: continuous 60 seconds
Amplitude: 20 W (30%)
Vibration start temperature: 23° C.±1.5° C.

(3) The resulted dispersion liquid was suction filtered with a filter paper (trade name: qualitative filter paper (No. 2, 110 mm), product of Advantec Toyo Kaisha, Ltd.), washed again with ion-exchange water twice, and filtered. After removing the liberated external additive, the toner was dried. The toner base particle from which the external additive had been removed was thus obtained.

The dispersion state of the inorganic filler at the surface of the toner base particle was observed using a scanning electron microscope (SU8230, product of Hitachi High-Technologies Corporation). The observation conditions involve a backscattered electron image mode and an acceleration voltage of 0.8 kV.

The captured backscattered electron image was binarized using image processing software to determine the area S1 of the entire toner base particle. The high-intensity contrast portion of the inorganic filler was binarized in the same manner. The total area S2 of the inorganic filler exposed at the surface of the toner base particle was determined from the area distribution of the high-intensity contrast portion. The area distribution of the total area S2 of the inorganic filler was determined from the above-determined S2, then the standard deviation SD [m²] was determined.

### Particle Diameter and Charge Ratio B/A

The volume average particle diameter [μm], charge amount Q [fC], and particle diameter D [μm] of each of the toners 1 to 16 were measured using a charge distribution analyzer E-SPART ANALYZER (product of Hosokawa Micron Corporation). The measurement procedure was as follows.

Each developer, in which each of the toners 1 to 16 and a carrier were mixed to have a toner concentration of 7% by mass, was placed in a cylindrical container (having a diameter of 25 mm and a length of 30 mm) and stirred for 1 minute at a rotation speed of 280 rpm. Next, the developer was magnetically adhered to the disk of the E-SPART ANALYZER, air was blown to the developer to separate the toner from the carrier, and the charge amount and particle diameter of the toner were measured.

The measurement conditions for the E-SPART ANALYZER involve a nitrogen gas flow rate of 0.3 NL/min and a gas pressure of 0.3 atm. The total number of measured particles was 3,000, and the true specific gravity of the particles was 1.2 g/cm³.

An average value “A” being the average of Q1/D1 was determined, where Q1 and D1 respectively represent a charge amount and a particle diameter of one of the toner particles having a particle diameter of 4.0 μm or more and less than 6.0 m when measured by the charge distribution analyzer. Further, an average value “B” being the average of Q2/D2 was determined, where Q2 and D2 respectively represent a charge amount and a particle diameter of one of the toner particles having a particle diameter of 6.0 μm or more and less than 8.0 μm.

### Evaluations

The toners 1 to 16 were subjected to the following evaluations (toner scattering, background stains, low-temperature fixability), and a comprehensive judgment was made. The results are shown in Table 1.

Toner scattering and background stains were evaluated by a durability test in which a chart having an image area ratio of 5% was continuously output on 50,000 sheets with each of the toners prepared in the above Examples and Comparative Examples using IMAGIO MP C5000, product of Ricoh Co., Ltd. The chart output on the sheets before and after the durability test were compared and evaluated by visual observation.

### Toner Scattering

The state of in-machine contamination with toner was evaluated by visual observation. The evaluation criteria are as follows. A, B, and C are acceptable, and D is unacceptable.

Evaluation Criteria

A: No contamination.

B: Contamination is observed near the developing part, but no contamination at the machine exhaust port.

C: Contamination is observed at the machine exhaust port.

D: Contamination is observed at the machine exhaust port, and scattered toner are deposited on the image.

### Background Stains

The degree of toner stains on the background of the transfers sheet was evaluated by visual observation. The evaluation criteria are as follows. A, B, and C are acceptable, and D is unacceptable.

Evaluation Criteria

A: No stain.

B: Almost no stain. No problem.

C: Stains are observed partially.

D: Stains are observed on the entire surface.

### Low-Temperature Fixability

A copy test was performed using a copier MF2200 (product of Ricoh Co., Ltd.) employing a TEFLON (registered trademark) roller as the fixing roller and the fixing unit of which had been modified, and a paper TYPE 6200 (manufactured by Ricoh Co., Ltd.). In the test, the cold offset temperature (lower-limit fixable temperature) was determined by varying the fixing temperature. The lower-limit fixable temperature was evaluated while setting the sheet feed linear speed to 120 to 150 mm/sec, the surface pressure to 1.2 kgf/cm², and the nip width to 3 mm. The lower-limit fixable temperature of conventional low-temperature fixing toner is about 130° C.

The evaluation criteria are as follows. A, B, and C are acceptable, and D is unacceptable.

Evaluation Criteria

A: The lower-limit fixable temperature is lower than 120° C.

B: The lower-limit fixable temperature is 120° C. or higher and lower than 125° C.

C: The lower-limit fixable temperature is 125° C. or higher and lower than 130° C.

D: The lower-limit fixable temperature is 130° C. or higher.

### Comprehensive Judgment

The criteria for comprehensive judgment are as follows. A, B, and C are acceptable, and D is unacceptable.

Evaluation Criteria

D: At least one of the evaluation results for the above three items is D rank.

C: At least one of the evaluation results for the above three items is C rank.

B: None of the evaluation results for the above three items is D rank or C rank.

A: The comprehensive judgment is B rank, and two or more of the evaluation results for the above three items are A rank.

TABLE 1

| | | Volume | Inorganic | Inorganic | | | | | | |
|---|---|---|---|---|---|---|---|---|---|---|
| | | Average | Filler | Filler | | | | | | |
| | | Particle | Degree of | Standard | Charge | | | | Low- | |
| | | Diameter | Exposure | Deviation | Ratio | Inorganic Filler | Toner | Background | temperature | Comprehensive |
| | | [μm] | S2/S1 | SD [μm²] | B/A | Type | Scattering | Stains | Fixability | Judgment |
| Example 1 | Toner 1 | 5.0 | 0.45 | 0.011 | 0.96 | Montmorillonite | A | A | A | A |
| Example 2 | Toner 2 | 5.1 | 0.52 | 0.038 | 0.74 | Montmorillonite | B | B | A | B |
| Example 3 | Toner 3 | 5.2 | 0.30 | 0.012 | 0.88 | Montmorillonite | A | B | A | A |
| Example 4 | Toner 4 | 4.5 | 0.69 | 0.017 | 0.95 | Montmorillonite | A | A | B | A |
| Example 5 | Toner 5 | 5.4 | 0.40 | 0.015 | 0.92 | Bentonite | A | A | A | A |
| Example 6 | Toner 6 | 4.8 | 0.50 | 0.031 | 0.74 | Kaolin Clay | C | B | B | C |
| Example 7 | Toner 7 | 5.5 | 0.66 | 0.037 | 0.70 | Barium Sulfate | C | B | C | C |
| Example 8 | Toner 8 | 5.2 | 0.65 | 0.018 | 0.96 | Barium Sulfate | B | B | B | B |
| Example 9 | Toner 9 | 5.0 | 0.55 | 0.016 | 0.92 | Montmorillonite | A | A | C | C |
| Comparative | Toner 10 | 5.1 | 0.48 | 0.051 | 0.60 | Montmorillonite | D | D | B | D |
| Example 1 | | | | | | | | | | |
| Comparative | Toner 11 | 5.1 | 0.66 | 0.080 | 0.72 | Montmorillonite | B | C | D | D |
| Example 2 | | | | | | | | | | |
| Comparative | Toner 12 | 5.3 | 0.24 | 0.018 | 0.56 | Montmorillonite | D | D | A | D |
| Example 3 | | | | | | | | | | |
| Comparative | Toner 13 | 5.6 | 0.78 | 0.040 | 0.85 | Montmorillonite | A | B | D | D |
| Example 4 | | | | | | | | | | |
| Comparative | Toner 14 | 5.8 | 0.50 | 0.180 | 0.60 | Montmorillonite | D | D | D | D |
| Example 5 | | | | | | | | | | |
| Comparative | Toner 15 | 5.2 | 0.15 | 0.006 | 0.92 | Montmorillonite | D | D | A | D |
| Example 6 | | | | | | | | | | |
| Comparative | Toner 16 | 5.3 | 0.75 | 0.018 | 0.90 | Montmorillonite | A | B | D | D |
| Example 7 | | | | | | | | | | |

It is clear from these results that the toner of the present disclosure that satisfies requirements for S2/S1, standard deviation SD, particle diameter, and B/A delivers good results in the evaluation of background stains, toner scattering, and low-temperature fixability.

In particular, the toners of Examples 1 to 5 each containing a layered inorganic mineral containing aluminum as an inorganic filler delivered good results of A or B rank in the evaluations of toner scattering and background stains. In Examples 6 and 7, the inorganic filler was not a layered inorganic mineral, and the evaluation result for toner scattering was C rank, which was slightly inferior to the toners containing the layered inorganic mineral.

In Comparative Example 1, the inorganic filler was not sufficiently fine, and the evaluation results for toner scattering and background stains were D rank.

In Comparative Example 2, since the amount of addition of the inorganic filler was increased, the evaluation results for toner scattering and background stains were good, but that for low-temperature fixability was D rank.

In Comparative Example 3, the evaluation results for toner scattering and background stains were D rank because the amount of the inorganic filler exposed at the surface of the toner base particles was small.

In Comparative Example 4, although the inorganic filler was in the form of fine grain, the amount of the inorganic filler exposed at the surface of the toner base particles was too large, so that the evaluation result for low-temperature fixability was D rank.

In Comparative Example 5, since the amount of the surfactant used to prepare the toner particles was reduced, the number of toner particles having a particle diameter of 6.0 μm or more and less than 8.0 μm was increased. Although the inorganic filler was sufficiently in the form of fine grain, B/A was not sufficient, so that the evaluation results for toner scattering, background stains, and low-temperature fixability were D rank.

In Comparative Example 6, although the inorganic filler was in the form of fine grain, the amount thereof was too small, so that the evaluation results for toner scattering and background stains were D rank.

In Comparative Example 7, although the inorganic filler was in the form of fine grain, the amount thereof was too large, so that the evaluation result for low-temperature fixability was D rank.

According to the present disclosure, the toner is able to respond to the demand of high speed and high reliability image forming methods. The toner has a sufficiently high charging ability, forms an image with less background stains, does not scatter in machines, and exhibits low-temperature fixability.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A toner comprising:
toner particles each comprising:
a toner base particle comprising a binder resin, a colorant, and an inorganic filler; and
an external additive,
wherein:
in a backscattered electron image of the toner from which the external additive has been removed, obtained using a scanning electron microscope, the following relation is satisfied:
0.30≤S2/S1≤0.70
where S1 represents an area of the toner base particle and S2 represents a total area of the inorganic filler exposed at a surface of the toner base particle,
a standard deviation SD of an area distribution of the total area S2 of the inorganic filler exposed at the surface of the toner base particle is less than 0.040 μm²,
a volume average particle diameter of the toner, measured using a charge distribution analyzer, is 4.0 μm or more and less than 6.0 μm, and
the following relation is satisfied:
B/A≥0.7
where A is an average value of Q1/D1 where Q1 and D1 respectively represent a charge amount and a particle diameter of one of the toner particles having a particle diameter of 4.0 μm or more and less than 6.0 μm, and B is an average value of Q2/D2 where Q2 and D2 respectively represent a charge amount and a particle diameter of one of the toner particles having a particle diameter of 6.0 μm or more and less than 8.0 m, where the particle diameter is measured using the charge distribution analyzer.

2. The toner of claim 1, wherein the standard deviation SD of the area distribution of the total area S2 of the inorganic filler exposed at the surface of the toner base particle is less than 0.02 μm², and B/A≥0.9 is satisfied.

3. The toner of claim 1, wherein the inorganic filler comprises a layered inorganic mineral containing aluminum, and at least part of interlayer ions is modified with an organic ion.

4. The toner of claim 1, wherein the binder resin comprises a polyester resin.

5. A toner accommodating unit comprising:
a container; and
the toner of claim 1 contained in the container.

6. An image forming apparatus comprising:
an electrostatic latent image bearer;
an electrostatic latent image forming device configured to form an electrostatic latent image on the electrostatic latent image bearer;
a developing device containing the toner of claim 1, configured to develop the electrostatic latent image with the toner to form a visible image;
a transfer device configured to transfer the visible image onto a recording medium; and
a fixing device configured to fix the visible image on the recording medium.

7. An image forming method comprising:
forming an electrostatic latent image on an electrostatic latent image bearer;
developing the electrostatic latent image with the toner of claim 1 to form a visible image;
transferring the visible image onto a recording medium; and
fixing the visible image on the recording medium.
